(19) United States
(12) Patent Application Publication
(10) Pub. No.: US 2026/0330359 A1
(43) Pub. Date: Oct. 22, 2026

(54) Computing System and Method for Automatically Creating Workflow Templates for Construction Tasks

(71) Applicant: Procore Technologies, Inc., Carpinteria, CA (US)

(72) Inventors: Frank Walfir Olson, Reno, NV (US); Brian Lee White Eagle, Austin, TX (US)

(21) Appl. No.: 19/180,835

(22) Filed: Apr. 16, 2025

(51) Int. Cl. G06Q 10/0631; G06Q 50/08

(52) U.S. Cl. CPC G06Q 10/06316; G06Q 50/08

(57) ABSTRACT

A computing platform is configured to: (i) receive image data that includes a graphical representation of the given workflow for the construction task, (ii) based on the natural-language request and the image data, generate a prompt for at least one generative AI model that comprises a request to generate the given workflow-template data object, (iii) pass the prompt to the at least one generative AI model, (iv) receive, from the at least one generative AI model, a response that comprises the given workflow-template data object, and (v) present, using the client device, a visual representation of the given workflow-template data object that comprises a depiction of the data related to each of the set of steps.

### BACKGROUND

Increasingly, parties involved in construction projects are beginning to use software applications to manage those construction projects. One example of such a software application is the software-as-a-service (SaaS) application for construction management offered by Procore Technologies, Inc. (“Procore”), who is the current applicant. Using construction management software applications such as these, parties can create a digital representation of a given construction project that is to be managed and then create, store, view, and/or interact with various types of data associated with the given construction project. Such data may include contracts, sub-contracts, specifications, drawings, building information model (BIM) files, requests for information (RFIs), punch lists (e.g., which list work that has not yet been completed or has been completed incorrectly), safety plans, work breakdown structures, change orders, inspection documents (e.g., which record information about the results of inspections), construction submittals (e.g., mock-ups or other documents that contractors create to depict proposed plans), construction site observation reports, project management records (e.g., project schedules and project budgets), third-party records (e.g., applicable zoning restrictions, real-estate title records and purchase records, records of public hearings pertinent to the given construction project), directories, invoices, timesheets, meeting minutes, sensor data, and daily logs (e.g., which record information about each day work is done at a work site of the construction project), among many other examples of project data that may be stored for a construction project.

### SUMMARY

Disclosed herein is new software-based technology for utilizing an AI-based software architecture to create or update workflow-template data objects.

In one aspect, the disclosed technology may take the form of a method that involves (i) receiving image data that includes a graphical representation of the given workflow for the construction task, (ii) based on the natural-language request and the image data, generating a prompt for at least one generative AI model that comprises a request to generate the given workflow-template data object, (iii) passing the prompt to the at least one generative AI model, (iv) receiving, from the at least one generative AI model, a response that comprises the given workflow-template data object, and (v) presenting, using the client device, a visual representation of the given workflow-template data object that comprises a depiction of the data related to each of the set of steps.

The functionality for generating the prompt for at least one generative AI model may take any of various forms. For example, generating the prompt for the at least one generative AI model may comprise generating a prompt that comprises (i) the natural-language request, (ii) the image data, (iii) a workflow template schema that defines a data structure for workflow-template data objects, and (iv) the request to create the given workflow-template data object.

The request to create the given work-flow template data object may take any of various forms. For example, the request to create the given workflow-template data object may comprise (i) a request to extract unstructured data related to the given workflow from the image data and (ii) a request to, based on the extracted unstructured data and the workflow template schema, generate data in accordance with the workflow template schema and thereby create the given workflow-template data object.

The unstructured data may take any of various forms. For example, the unstructured data may comprise data related to a set of steps for the given workflow for the construction task.

The at least one generative AI model may take any of various forms. In one example, the at least one generative AI model may comprise a multi-modal generative AI model.

Additionally or alternatively, the generative AI model may comprise a first generative AI model and a second generative AI model. In such an example, the prompt may comprise a first prompt and a second prompt and the functionality for generating the prompt may comprise (i) generating the first prompt that comprises the image data and the request to extract the unstructured data related to the given workflow from the image data and (ii) generating the second prompt that comprises the extracted unstructured data and the request to, based on the extracted unstructured data and the workflow template schema, generate data in accordance with the workflow template schema and thereby create the given workflow-template data object. Further, in such an example, the functionality for passing the prompt to the at least one generative AI model may comprise (i) passing the first prompt to the first generative AI model and (ii) passing the second prompt to the second generative AI model.

The disclosed method may further involve initializing an initial workflow-template data object. In such an example, the functionality for generating the prompt may comprise based on (i) the natural-language request, (ii) the image data, and (iii) the initial workflow-template data object, generating a prompt for at least one generative AI model that comprises a request to generate the given workflow-template data object. Further yet, the method may involve extracting, from the natural-language request, a request to initialize the initial workflow-template data object and, in such an example, initializing the initial workflow-template data object may comprise based on the request to initializing the initial workflow-template data object, initialize the initial workflow-template data object.

The disclosed method may further involve (i) after receiving the given workflow-template data object, receiving a natural-language request to update the given workflow-template data object, (ii) generating a second prompt for the at least one generative AI model that comprises (a) the natural-language request to update the given workflow-template data object (b) the given workflow-template data object, and (c) a request to, based on the natural-language request and the given workflow-template data object, generate an updated workflow-template data object, (iii) pass the second prompt to the at least one generative AI model, and (iv) receiving, from the at least one generative AI model, a response that comprises the updated workflow-template data object. Further yet, the method may involve after presenting the visual representation of the given workflow-template data object, presenting, using the client device, a visual representation of the updated workflow-template data object

In another aspect, the disclosed technology may take the form of a computing system comprising at least one processor, at least one non-transitory computer-readable medium, and program instructions stored on the at least one non-transitory computer-readable medium that are executable by the at least one processor such that the computing platform is configured to carry out the functions of the aforementioned method.

In yet another aspect, the disclosed technology may take the form of a non-transitory computer-readable medium comprising program instructions stored thereon that are executable to cause a computing system to carry out the functions of the aforementioned method.

Features, aspects, and advantages of the presently disclosed technology may be better understood with regard to the following description, appended claims, and accompanying drawings, as listed below. The drawings are for the purpose of illustrating example embodiments, but those of ordinary skill in the art will understand that the technology disclosed herein is not limited to the arrangements and/or instrumentality shown in the drawings.

### BRIEF DESCRIPTION OF THE DRAWINGS

FIG. 1 depicts an example network configuration in which example embodiments may be implemented.

FIG. 2A depicts a GUI view of a Workflows tool of a construction management software application.

FIG. 2B depicts a visual representation of a workflow template as presented via the GUI view of FIG. 2A.

FIG. 3 depicts an example block diagram for an AI-based software architecture that enables a user to control a construction management software application through input of natural-language and image-based requests.

FIG. 4A depicts an example first GUI view of an example workspace for generating workflow-template data objects.

FIG. 4B depicts an example second GUI view of the example workspace for generating workflow-template data objects.

FIG. 5 depicts a communication diagram that depicts communications between components shown in FIG. 3 and is shown in accordance with the functionality disclosed herein.

FIG. 6 depicts one possible implementation of functionality that may be carried out by the example AI-based software architecture of FIG. 3.

FIG. 7 is a simplified block diagram illustrating some structural components that may be included in an example computing platform that may be configured to perform some or all of the server-side functions disclosed herein.

FIG. 8 is a simplified block diagram illustrating some structural components that may be included in an example client device that may be configured to perform some or all of the client-side functions disclosed herein.

Features, aspects, and advantages of the presently disclosed technology may be better understood with regard to the following description, appended claims, and accompanying drawings, as listed below. The drawings are for the purpose of illustrating example embodiments, but those of ordinary skill in the art will understand that the technology disclosed herein is not limited to the arrangements and/or instrumentality shown in the drawings.

### DETAILED DESCRIPTION

The following disclosure refers to the accompanying figures and several examples. One of ordinary skill in the art would understand that such references are for the purpose of explanation only and are therefore not meant to be limiting. Part or all of the disclosed systems, devices, and methods may be rearranged, combined, added to, and/or removed in a variety of manners, each of which is contemplated herein.

As noted above, construction management today is often performed through the use of software applications, such as the software application for construction management provided by Procore Technologies, Inc.®, the applicant of the present disclosure. These construction management software applications generally provide users with the ability to create, store, view, and/or interact with various types of digital data related to a construction project. In practice, these construction management software applications may take various forms.

As one possible implementation, a construction management software application may include both front-end software (e.g., a web application, desktop application, or mobile application) running on client devices that are accessible to individuals associated with construction projects (e.g., contractors, project managers, architects, engineers, designers, etc.) and back-end software running on a back-end computing platform (sometimes referred to as a “cloud” platform) that interacts with and/or drives the front-end software, and which may be operated (either directly or indirectly) by the provider of the front-end software. This form of a software application may be referred to as a client-server application or a software-as-a-service (SaaS) application, among other possibilities. As another possible implementation, a construction management software application may include front-end software that runs on client devices without interaction with a back-end computing platform. These construction management software applications may take other forms as well.

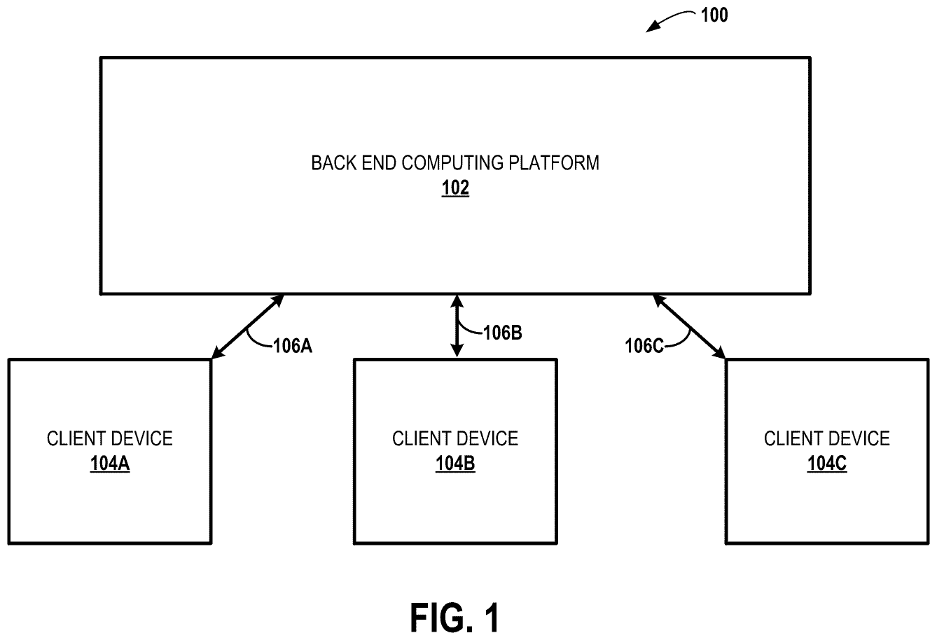

Turning now to the figures, FIG. 1 depicts an example network environment 100 in which a construction management software application may be implemented. As shown in FIG. 1, the network environment 100 includes a back-end computing platform 102 that may be communicatively coupled to one or more client devices 104, which as shown includes the client device 104A, the client device 104B, and the client device 104C. Although the client devices 104 are depicted by three devices as shown for the sake of simplicity in illustration, it should be understood that the client devices 104 may represent more or less than three devices without departing from the spirit and scope of this disclosure.

Broadly speaking, the back-end computing platform 102 may comprise one or more computing systems that have been provisioned with back-end software for a construction management software application, which may include program code for carrying out one or more of the platform-side functions disclosed herein. The one or more computing systems of back-end computing platform 102 may collectively comprise some set of physical computing resources (e.g., one or more processors, data storage system, communication interfaces, etc.), which may take various forms and be arranged in various manners.

For instance, as one possibility, the back-end computing platform 102 may comprise computing infrastructure of a public, private, and/or hybrid cloud (e.g., computing and/or storage clusters) that has been provisioned with back-end software for the construction management software application. In this respect, the entity that owns and operates the back-end computing platform 102 may supply its own cloud infrastructure or obtain the cloud infrastructure from a third-party provider of “on demand” computing resources, such as Amazon Web Services (AWS) or the like. As another possibility, the back-end computing platform 102 may comprise one or more dedicated servers that have been provisioned with back-end software for the construction management software application.

Further, in practice, the back-end software installed at the back-end computing platform 102 may be implemented using any of various software architecture styles, examples of which may include a microservices architecture, a service-oriented architecture, and/or a serverless architecture, among other possibilities, as well as any of various deployment patterns, examples of which may include a container-based deployment pattern, a virtual-machine-based deployment pattern, and/or a Lambda-function-based deployment pattern, among other possibilities.

Further yet, although not shown in FIG. 1, the back-end software installed at the back-end computing platform 102 may interact with a data storage layer of the back-end computing platform 102, which may comprise data stores of various different forms, examples of which may include relational databases (e.g., Online Transactional Processing (OLTP) databases), NoSQL databases (e.g., columnar databases, document databases, key-value databases, graph databases, etc.), file-based data stores (e.g., Hadoop Distributed File System), object-based data stores (e.g., Amazon S3), data warehouses (which could be based on one or more of the foregoing types of data stores), data lakes (which could be based on one or more of the foregoing types of data stores), message queues, or streaming event queues, among other possibilities.

The back-end computing platform 102 may comprise various other components and take various other forms as well.

In turn, the client devices 104 may each be any computing device that is capable of running front-end software of the construction management software application, which may include program code for carrying out the client-side functions disclosed herein. In this respect, the client devices 104 may each include hardware components such as one or more processors, computer-readable mediums, communication interfaces, and input/output (I/O) components (or interfaces for connecting thereto), among others, as well as software components that facilitate the client device's ability to run the front-end software (e.g., operating system software, web browser software, etc.). As representative examples, the client devices 104 may each take the form of a desktop computer, a spatial computer, a laptop, a netbook, a tablet, a smartphone, and/or a personal digital assistant (PDA), among other possibilities.

As further depicted in FIG. 1, the back-end computing platform 102 is configured to interact with the client devices 104 over respective communication paths 106, of which communication paths 106A, 106B, and 106C are shown as examples. In this respect, each respective communication path 106 between the back-end computing platform 102 and one of the client devices 104 may generally comprise one or more communication networks and/or communications links, which may take any of various forms. For instance, each respective communication path 106 with the back-end computing platform 102 may include any one or more of Personal Area Networks (PANs), Local-Area Networks (LANs), Wide-Area Networks (WANs) such as the Internet or cellular networks, cloud networks, and/or point-to-point links, among other possibilities. Further, the communication networks and/or links that make up each respective communication path 106 with the back-end computing platform 102 may be wireless, wired, or some combination thereof, and may carry data according to any of various different communication protocols. Further yet, communications over each respective communication path 106 could be carried out via an Application Programming Interface (API), among other possibilities. Still further, although not shown, the respective communication paths 106 between the client devices 104 and the back-end computing platform 102 may also include one or more intermediate systems. For example, it is possible that the back-end computing platform 102 may communicate with a given client device 104 via one or more intermediary systems, such as a host server (not shown). The respective communication paths 106 between the back-end computing platform 102 and the client devices 104 may take other forms as well.

Although not shown in FIG. 1, the back-end computing platform 102 may also be configured to receive data, such as data related to a construction project, from one or more external data sources, such as an external database and/or another back-end computing platform or platforms. Such data sources—and the data output by such data sources—may take various forms.

It should be understood that the network environment 100 depicted in FIG. 1 is one example of a network environment in a construction management software application may be implemented. Numerous other arrangements are possible and contemplated herein. For instance, other network configurations may include additional components not pictured and/or more or fewer of the pictured components.

When a given party (e.g., a company or individual involved in the construction industry) wishes to utilize an existing construction management software application, the given party may begin by (i) creating an account with the construction management software application and (ii) adding a set of one or more individuals associated with the given party as users on the given party's account. Thereafter, the construction management software application may enable the users of the given party to create, store, view, and/or interact with digital data related to construction projects that involve the given party.

For instance, for each of one or more construction projects that involve the given party, the construction management software application may enable users of the given party to create a new project workspace for the construction project (or join an existing project workspace for the construction project that was previously created) and then (ii) create, store, view, and/or interact with any of various types of data objects related to management of construction projects.

In practice, each different type of data object that is supported by a construction management software application may be designed to serve a particular purpose within the construction management software application and may comprise a particular set of data elements that facilitate that particular purpose. For instance, a first type of data object may be designed to serve a first purpose within the construction management software application and may comprise a first set of data elements, a second type of project-related data object may be designed to serve a second purpose within the construction management software application and may comprise a second set of data elements that differs from the first set of data elements, and so on for each of the other types of data objects. In this way, the users of the construction management software application may utilize different types of data objects to manage different aspects of the construction project.

As some representative examples, the types of data objects that may be supported by a construction management software application may include, workflow-template data objects (e.g., a data object comprising data that represents a template for use in one or more instances of a workflow associated with construction project), budget data objects (e.g., a data object comprising data that is representative of a budget (and/or any modifications thereof) for a construction project), change-order data objects (e.g., a data object comprising data that represents a change to an aspect of a construction project and/or a change to a data object that is associated with the aspect of the construction project), payments data objects (e.g., a data object comprising data associated with a payment from one party using the construction management software application to another party), contracts data objects (e.g., a data object comprising data that is representative of a contract or proposal utilized in the course of a construction project), correspondence data objects (e.g., a data object comprising data associated with correspondence amongst parties to a construction project), submittal data objects (e.g., a data object comprising data that represents an item submitted by a responsible contractor to a general contractor of a construction project for review and approval), among other types of construction-related data objects.

In at least some implementations, the software features for creating, storing, viewing, and/or interacting with the different types of data objects that are supported by a construction management software application may be arranged into different software “tools” that each correspond to a different type of data object. For instance, a construction management software application may include a “Workflows” tool for creating, storing, viewing, and/or interacting with workflow-template data objects for construction projects, a “Payments” tool for creating, storing, viewing, and/or interacting with payments data objects, a “Budget” tool for creating, storing, viewing, and/or interacting with budget data objects, a “Commitments” tool for creating, storing, viewing, and/or interacting with data objects related to given parties'commitments during a construction project (such data objects may include, but are not limited to including, invoice data objects, contract data objects, change-order data objects, etc.), a “Correspondence” tool for creating, storing, viewing, and/or interacting with correspondence data objects, a “Punch Items/Lists” tool for creating, storing, viewing, and/or interacting with punch list and/or punch item data objects, a “Daily Logs” tool for creating, storing, viewing, and/or interacting with daily log data objects, an “RFIs” tool for creating storing, viewing, and/or interacting with RFI data objects, and/or an “Inspections” tool for creating, storing, viewing, and/or interacting with inspections data objects, among various other examples of software tools that may be included within a construction management software application. However, in other implementations, the software features for creating, storing, viewing, and/or interacting with the different types of data objects that are supported by a construction management software application may be arranged in other manners (e.g., software features that operate across multiple different types of data objects) that are not based solely on a software tools paradigm.

In general, each such software tool has its own respective graphic user interface (GUI) that may be utilized by a user to perform various actions within the software tool, such as actions related to creating, storing, viewing, and/or interacting with data objects of a type that is associated with the software tool. To provide functionality related to these actions, the GUI for the software tool may comprise various individual GUI views (also sometimes referred to as screens or pages of the GUI), and in order to carry out actions via the GUI of a software tool, a user may need to navigate through multiple different GUI views and/or may need to provide multiple different GUI inputs.

Software tools of a construction management software application may be utilized as an interface for one or more users to interact with the construction management software application. For example, a Workflows tool may be utilized to plan workflows for managing construction projects. In some examples, the Workflows tool may interact with other software tools of the construction management software application to perform various functions for accomplishing tasks during a construction project.

At a high level, a workflow for a construction project may be a sequence of processes (or “steps” to a workflow) through which a construction task proceeds from an initiation of the workflow to completion of the workflow. In the context of a construction management software application, a workflow may refer to a sequence of steps through which a construction task is completed by one or more users of the construction management software application (e.g., via the one or more users'use of one or more software tools of the construction management software application). In this regard, a workflow may be a set of sequential steps that are either (i) taken by one or more parties to the workflow for the construction task (e.g., by utilizing one or more software tools during a workflow) or (ii) decided based on conditions (e.g. limits for parameters to a workflow) associated with the workflow.

In some examples, a given workflow performed with assistance from a construction management software application may have various features of the workflow defined by a workflow template. A workflow template, in general, refers to a data object that defines a sequence of steps for one or more parties-to-a-workflow to carry out (e.g., utilizing one or more tools of the construction management software application) to complete a given a construction task. In this regard, when a workflow template is instantiated to assist in completing a given construction task, this instantiation of the workflow template within the construction management software application may be considered a “workflow instance.”

Workflow templates may be utilized to assist with construction tasks that may have a construction-task type. A construction-task type may refer to a type of task that one or more parties to a given workflow can perform utilizing the construction management software application (and any software tools, thereof). Examples of construction-task types that may benefit from implementing workflow templates to carry out instances of workflows based on the workflow template include, but are not limited to including, assignment of sub-tasks for a construction project task to parties to a workflow (e.g., to whom a change order is assigned, to whom approvals/denials of an item are assigned, etc.), approvals of various items associated with a construction project (e.g., approvals/denials of submittals, change orders, payments, etc.), among other contemplated construction project tasks.

A “party” to a workflow may refer to individuals or organizations (including sub-groups of organizations) that may contribute to a workflow. Further, a party to a workflow may have a role, for the purposes of a workflow. For example, a role for a party to a workflow may correspond with an organizational role that the party to the workflow occupies within the party's respective organization (e.g., a manager of a group of individuals in the respective organization, an executive in the respective organization, a project lead for a given construction project that is being handled by the organization, etc.). It is contemplated that, in the course of carrying out a workflow based on a given workflow template, that one or more individual steps of the workflow may be required to be executed by a party to the workflow that has a given role. In such examples, the roles for parties to the workflow that are required to carry out various steps to the workflow may be defined via a workflow template, from which a workflow instance for the workflow is instantiated.

A workflow instance may correspond to a given performance of a given construction task (of, for example, a given construction-task type) that is performed via one or more users (e.g., parties to a workflow) interacting with the construction management software application in accordance with steps defined by a given workflow template. When a workflow instance is carried out, a construction task may thereby be performed (at least in part), utilizing the construction management software application to assist users in performing the construction task.

In practice, workflow templates within the construction management software application may be represented in the form of workflow-template data objects, which are data objects that define features of a workflow template. To provide functionality related to workflows and/or workflow templates associated with workflows, the Workflows tool provides software features for creating, storing, viewing, and/or interacting with workflow-template data objects.

A workflow-template data object may, thus, comprise data that is representative of a workflow template that can be used within the construction management software application (e.g., within the Workflows tool). A workflow-template data object may take the form of a data object created according to a workflow template schema that is readable by the construction management software application, such that the workflow-template data object can be interacted with via the Workflows tool (or various other components of the construction management software application). A workflow template schema may comprise a formatted data structure that organizes data for a workflow template that is then readable by the construction management software application.

In an example, a workflow-template data object may comprise a data object that (i) is configured for use within the construction management software application based on the workflow template schema and (ii) contains attribute data that defines the attributes of its associated workflow template. A workflow-template data object and its associated workflow template schema may take any of various interchange formats, such as, but not limited to, the JavaScript Object Notation (JSON) format. To that end, it is contemplated that a workflow-template data object may comprise a JSON-based data object that conforms to a workflow template schema that comprises a JSON-based schema that is configured to format the JSON-based data object for use with the Workflows tool.

In terms of the data content therein, a workflow-template data object may comprise a data object that includes data that defines (i) various steps for the workflow template and/or (ii) data defining conditions that govern how the various steps for the workflow template will function. By reading the data related to various steps of the workflow template and the data defining the conditions for the various steps, the Workflows tool may utilize workflow-template data objects to (i) generate a visual representation of a given workflow template based on a given workflow-template data object and/or (ii) instantiate a given workflow instance based on the workflow template that is represented via the given workflow-template data object. The Workflows tool may comprise various other features for creating, editing, storing, viewing, and/or interacting with workflow-template data objects and may include various other functionality related to workflow templates and associated workflow-template data objects.

In view of the above, organizations that use the construction management software application may utilize the Workflows tool to both (i) generate workflow templates based on a workflow for the organization to execute construction project tasks of a given construction-task type and (ii) select workflow templates to assign to construction project tasks, such that each workflow template may be instantiated with respect to a given construction project task to assist users within the organization to complete the given construction project task. It is further contemplated that the Workflows tool may comprise additional functionality for assisting users within an organization to carry out workflows and such functionality may take any of various other forms.

To enable a user to utilize this functionality, the Workflows tool may comprise a GUI (a “Workflows GUI”) that comprises various individual GUI views (“Workflows GUI views”), which are each presented to a user in order to enable a user to (i) generate workflow templates (in the form of workflow-template data objects) based on a workflow for the organization to execute construction project tasks of a given construction-task type and (ii) select workflow templates (and thereby select an associated workflow-template data object) to assign to construction project tasks, such that the workflow templates may be instantiated with respect to a given construction project task to assist users within an organization to complete the given construction project task. As will be described in detail herein, the Workflows tool may comprise a workspace within a Workflows GUI (and any Workflows GUI views thereof) that enables a user to provide user input to generate a workflow-template data object.

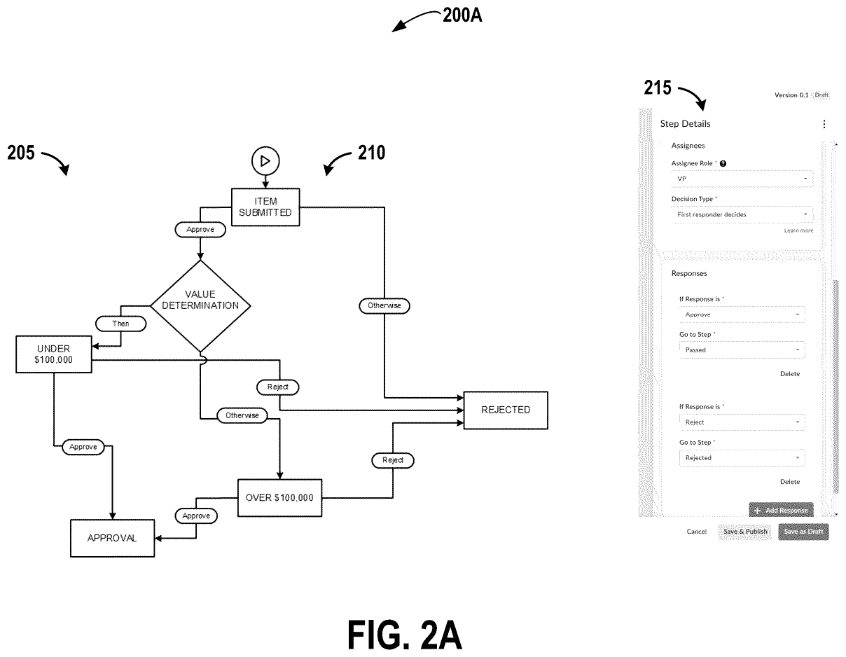

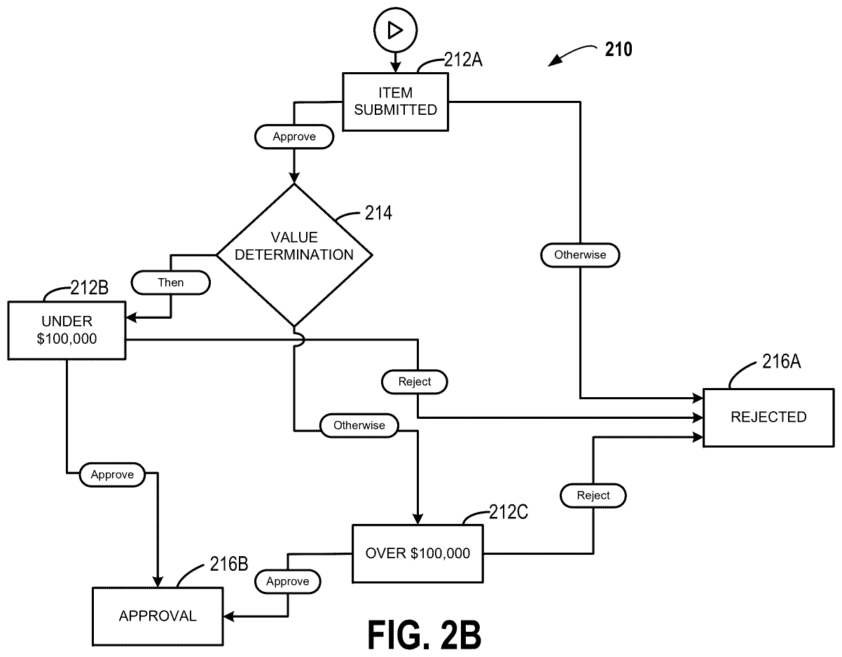

Turning to FIG. 2A, one illustrative example of a Workflows GUI view 200A of the Workflows GUI is shown. In line with the discussion above, the Workflows GUI view 200A may enable a user to provide input for generating a workflow-template data object within a workspace 205 of the Workflows GUI. To that end, the workspace 205 may be an environment in which a user can provide input to generate a workflow-template data object that is shown in a visual representation of a workflow template 210 (herein after referenced as the “workflow template 210,” but it should be understood that the workflow template 210 is a visual representation of a workflow-template data object). A zoomed-in version of the workflow template 210 is illustrated in greater detail in FIG. 2B, which will be referenced, below, in discussions of various functions of the Workflows tool.

For providing input to generate the workflow template 210, the Workflows GUI may provide a user with a variety of input-control elements through which users may input data for generating a workflow template (e.g., the workflow template 210). Such input-control elements could take any of various forms, examples of which may include a text field (e.g., a single-line text field or a multi-line text field), a selectable icon, a set of radio buttons, a set of check boxes, a slider (e.g., that allows a user to adjust a value within a range by moving a handle across a track), a date picker, an input stepper (e.g., a combination of a text box for displaying a value, a first button that increases the displayed value in response to being clicked, and a second button that decreases the displayed value in response to being clicked), a dropdown list, and/or combinations thereof, among other possible examples of input-control elements.

In the illustrated example of FIG. 2A, the Workflows GUI view 200A may receive input from a user via one or more input-control elements that may be included in an example sidebar 215. However, the Workflows tool (and any Workflows GUI or Workflows GUI views, thereof) are not limited to only including the example sidebar 215 as an input mechanism for generating the workflow template 210. The Workflows tool (and any Workflows GUI or Workflows GUI views, thereof) may comprise various other components for receiving input for generating a workflow template from a user and such components may take any of various forms.

For example, another form of input control element that may be presented to a user for generating a workflow template may be a pop-up window. In an example, a pop-up window may be presented to a user of the construction management software application when said user accesses the Workflows tool and, subsequently, is presented with a Workflows GUI view that includes the pop-up window. In the given example, the pop-up window may comprise a set of input-control elements that may be utilized in initializing a workflow template data object, via the Workflows tool. For example, the pop-up window may comprise a first input control element (e.g., a text box) that enables a user to input a title for a new workflow-template to-be-created. Further still, the pop-up window may comprise a second input control element (e.g., a dropdown list) that enables a user to select another software tool (other than the Workflows tool) of the construction management software application, with which the workflow-template-to-be-created will be used when carrying out various workflow instances that are based on the workflow-template-to-be-created.

In the example discussed thus far with respect to FIGS. 2A, 2B, the example workflow template 210 is described as being associated with actions that are performed using a tool for evaluating contracts (e.g., a “Contracts” or “Subcontracts” tool of the construction management software application). This associated software tool is merely included for the purposes of example and it is certainly contemplated that the workflow template 210 may be utilized in conjunction with various other tools of the construction management software application (e.g., a “Submittals” tool, an “RFI” tool, etc.).

Returning now to FIG. 2B and as discussed above, the workflow template 210 may comprise a variety of steps for a given workflow that are to be carried out using the workflow template 210 as a basis for carrying out a workflow instance for the given workflow. Each step of the workflow template 210 may comprise one or more data fields that are associated with completing of that step. Accordingly, the workflow-template data object (upon which the visualization for the workflows template 210 is based) may contain any data (for the one or more data fields) that define characteristics of the step, in conformance with the workflow template schema for the workflow-template data object. The data contained in a workflow-template data object related to each of a set of steps for a workflow template may take any of various forms.

As an example and as illustrated in FIG. 2B, the workflow template 210 may comprise one or more response steps 212, one or more condition steps 214, and/or one or more end steps 216. Each step of the workflow template 210 may be sequentially carried out, via user input or via execution by the Workflows tool when no user input is necessary, over the course of a workflow instance carried out using the workflow template 210.

A response step 212 of a workflow may be an action or process within the workflow that requires user input when a workflow instance based on the workflow template 210 is carried out. In some examples, a response step 212 may have an assignee assigned to the response step 212, which is a party that is to provide the user input for completing the response step 212. In some examples, the response step 212 may have an exact party defined as the assignee (e.g., an individual is made the assignee and must be the one who provides the input). Alternatively, the assignee to a response step 212 may be defined by a role within an organization that is using the workflow template 210 and, therefore, various members of the organization that occupy said role may qualify as the “assignee” of the response step 212 and, thus, are capable of providing the user input for the response step 212.

For example, the response step 212A, which indicates that an item related to a construction project task (e.g., a contract, a subcontract, etc.) has been submitted for review by an assignee to the response step 212A and a given workflow instance in accordance with the workflow template 210 will proceed based on user input to the response step 212A (e.g., whether or not an assignee to the response step 212A approves or denies the item). As illustrated, if the user input at the response step 212A indicates that the item is approved, then the workflow instance (in accordance with the workflow template 210) proceeds to the condition step 214; otherwise, if the user input at the response step 212 indicates otherwise, then the workflow instance (in accordance with the workflow template 210) proceeds to an end step 216A, that indicates that the item is rejected.

The condition step 214 is a step that contains a conditional statement that evaluates data associated with a previous response step 212. After evaluating the data associated with the previous response step 212, the condition step 214 routes the workflow instance (in accordance with the workflow template 210) based on the results of the evaluation. To that end, condition step(s) 214 may be steps that connect two or more steps and do not require user input to be carried out.

Consider the example illustrated in FIG. 2B, wherein the condition step 214 may evaluate a value for an item that is approved at the response step 212A. Based on an evaluation of the item (e.g., via inspecting data from a data object associated with the item), the condition step 214 may determine whether to route a workflow instance (in accordance with the workflow template 210) to either a second response step 212B or a third response step 212C. Thus, carrying out the condition step 214 does not require direct user input, but rather, may function to route operations of the workflow template 210 based on upstream data.

In the illustrated example of the workflow template 210, the condition step 214 may determine a value for the item and, based on that value, decide whether to route operations of a workflow instance (in accordance with the workflow template 210) to either the second response step 212B (e.g., if the value determined is under $100,000) or the third response step 212C (e.g., if the value determined is equal to or over $100,000). As one example, the condition step 214 may route a decision as to whether or not to approve the item to different response steps 212B, 212C, as the different response steps 212B, 212C may have different conditions under which approval or denial of the item can be made.

For example, the workflow template 210 is utilized by an organization that requires that approvals of items that will cost the organization under $100,000 are to be decided by a party to the organization that has a first role (e.g., a project manager role), whereas the organization requires that approval of items that will cost the organization $100,000 or greater are to be decided by a party to the organization that has a second role that has more authority than the first role, within the organization (e.g., the second role is an executive role). Thus, in this example, if at the condition step 214 it is determined that a value of an item is under $100,000, then a workflow instance (in accordance with the workflow template 210) proceeds to the second response step 212B (wherein approval of the item is to be made by a party having, at least, the first role); otherwise, the workflow instance proceeds to the third response step 212C (wherein approval of the item is to be made by a party having, at least, the first role).

As illustrated in FIG. 2B, regardless of how a workflow instance (in accordance with the workflow template 210) proceeds through various steps of the workflow instance, a workflow instance should, ultimately, end at an end step 216. The end steps 216 may be any step that terminates the workflow instance. Example end steps 216 may include, but are not limited to including, steps that end in an approval (e.g., approval of the item in end step 216B), steps that end in a denial (e.g., rejection of the item in end step 216A), steps that end in the assignment of another construction project task to a party, among other steps that terminate a workflow instance based on a workflow template.

In the illustrated example, it is shown that each of the response steps 212 may route to one of two end steps 216, based on the user input provided at each response step 212. For example, rejection at any of the response steps 212 results in a workflow instance (in accordance with the workflow template 210) terminating at the end step 216A, which may indicate a rejection of the item presented in the first response step 212A. Alternatively, at each of the second and third response steps 212B, 212C, if the party to the workflow who provides input that indicates that the item is to be approved, then the workflow instance (in accordance with the workflow template 210) proceeds to the second end step 216B, which may indicate approval of the item.

Further, while not illustrated as having a sequence wherein the condition step 214 routes to an end step 216, it is certainly contemplated that the condition step 214 could route to an end step 216. For example, consider (in the example of FIG. 2B) if the condition step 214 included another condition, wherein if the value of the item exceeds a maximum value, the item is automatically denied based on exceeding the maximum value-then, the condition step 214 may route to the end step 216A.

In creating a workflow template, data for various data fields for each of various steps (of various differing step types) for the workflow template will generally be input by a user of the Workflows tool. To that end, a Workflows GUI may comprise many Workflows GUI views comprising many input-control items that enable a user to input such data into such data fields. For example, consider a Workflows GUI view that comprises a set of input-control elements for entering data for each of one or more response steps 212-this may include various input-control elements for enabling a user to input general information related to the response step 212 (e.g., a name for the response step 212, a type of response step relative to the construction-task type, a status of the response step 212, timeline information for the response step 212, etc.), various input-control elements for a user to input assignee information (e.g., assignee identification, assignee role, type of decision for a given assignee, etc.), various input-control elements that define actions in response to user input to the response step 212 (e.g., information that governs actions occurring on approval at the response step 212, information that governs actions occurring upon denial at the response step 212, information related to a next step (e.g., a conditional step 214, another response step 212, an end step 216) to be created in response to either approval or denial at the response step 212, etc.), various input control elements indicating finalization or creation of the response step 212, among other contemplated input-control elements for enabling a user to input data associated with a response step. Similarly, when inputting data for creating condition steps 214 and/or end steps 216, many more GUI views for inputting data for condition steps 214 and/or end steps 216 may be presented to a user to enable them to input such data (e.g., via various input-control elements).

While such GUIs for software tools (such as the Workflows tool) provide useful functionality for enabling a user to create data objects (e.g., a workflow-template data objects), GUIs having a variety of GUI views may also present problems for the user of the construction management software application. For example, these GUIs may require multiple user inputs (e.g., multiple input entries via multiple input-control elements) to perform a single action. Additionally, these multiple user inputs may require that multiple different GUI views of the software tool be accessed and used, requiring the user to navigate through multiple different GUI views in order to perform an action. To that end, the number of user inputs and/or GUI views that are required to create a data object could become quite large.

The multiple user inputs and/or multiple GUI views that may be required to perform an action may make using a software tool cumbersome, inefficient, and/or time consuming for a user (and perhaps lead the user to not even attempt to perform actions at all, using the software tool). Additionally, the multiple user inputs and/or multiple GUI views that may be required to perform an action within a software tool may lead to problems on the construction project given the drawbacks, such as inefficiencies. Additionally yet, the multiple user inputs and/or multiple GUI views that may be required to perform an action may also lead to user error when the user performs an action (e.g., erroneous user input, such as mistyped data, wrong clicks on elements, etc.).

In particular regarding the generation of workflow templates, some users may initially create organizational workflows (and/or templates for such workflows) outside of the construction management software application (e.g., in graphic design software). This outside software may not necessarily be integrated with functionality of the construction management software application. In these situations, in order to actualize these externally generated workflows/workflow templates within the construction management software application, a user may then have to meticulously recreate all of the steps of a graphic version of a workflow template within the Workflows tool to be able to utilize the workflow as a template for operating within the construction management software application. This involves navigating through all of the aforementioned various GUI views, which ultimately takes up time that the user may not have.

For these and other reasons, there remains a need for technology that enables users to interact with construction management software applications in a different way.

To address these and other problems associated with existing construction management software applications, disclosed herein is new software technology that utilizes artificial intelligence (AI) to enable a user to control a construction management software application through input of natural-language requests (e.g., text-based and/or voice-based requests) and (ii) input of image data that includes a graphical representation of a workflow, upon which the workflow template is to be based. At a high level, the disclosed software technology comprises (i) front-end software that interacts with the user by receiving (a) natural-language requests and image data and (ii) back-end software that interprets and executes the natural-language requests in conjunction with an analysis of the image data, to generate workflow template data objects. In practice, the back-end software may function to (i) receive image data that includes a graphical representation of the given workflow for the construction task, (ii) based on the natural-language request and the image data, generate a prompt for at least one generative AI model that comprises a request to generate the given workflow-template data object, (iii) pass the prompt to the at least one generative AI model, (iv) receive, from the at least one generative AI model, a response that comprises the given workflow-template data object, and (v) present, using the client device, a visual representation of the given workflow-template data object that comprises a depiction of the data related to each of the set of steps.

The functionality that is provided by the disclosed software-based technology may take other forms as well.

The disclosed software technology improves upon existing construction management software applications by providing AI-based technology for interacting with various tools of construction management software applications in various ways. For instance, instead of requiring a user to navigate through a variety of GUI views to create data objects, the users may now create data objects by interacting with fewer GUI views (e.g., a GUI view (and its updated forms) that provides a chat interface for a user to input a natural-language requests and image data for creating data objects). Further still, instead of requiring the user to provide multiple inputs for data values related to attributes of the data object that a software tool may use to create the data object, by using the disclosed AI-based software architecture, the AI-based software architecture may generate data values for fields for such attributes, which are then used in generating data objects (e.g., workflow-template data objects). These improvements provided by the disclosed AI-based software architecture simplify the process of interacting with the software tool for performing various actions and their use may improve user-experience of construction management software applications.

In particular, these improvements may be particularly pronounced when the user desires to generate workflow-template data objects based on image data that either is (i) represented in a graphical form or (ii) contained in a data format that is not readable directly by the construction management software application (e.g., a data object comprising a data file for another application, having a different schema for generating image data that may be representative of a workflow or workflow template). By utilizing the disclosed AI-based technology, a user may utilize this image data (that, absent the AI-based technology would not be usable by the construction management software application) to generate workflow-template data objects for use within the construction management software application.

The improvements that are provided by the disclosed software technology are described in further detail below.

In practice, the disclosed software-based technology may be integrated into a construction management software application or provided as a standalone software tool, among other possibilities. For instance, as one possible implementation, the disclosed software-based technology may be integrated into a construction management software application comprising both front-end software running on client devices (e.g., client devices 104A-C of FIG. 1) that are accessible to individuals associated with construction projects (e.g., contractors, project managers, architects, engineers, designers, etc.) and back-end software running on a back-end computing platform (e.g., back-end computing platform 102 of FIG. 1) that interacts with and/or drives the front-end software. As another possible implementation, the disclosed software-based technology may be integrated into a construction management software application comprising front-end client software that runs on client devices without interaction with a back-end computing platform. The disclosed software-based technology may take other forms as well.

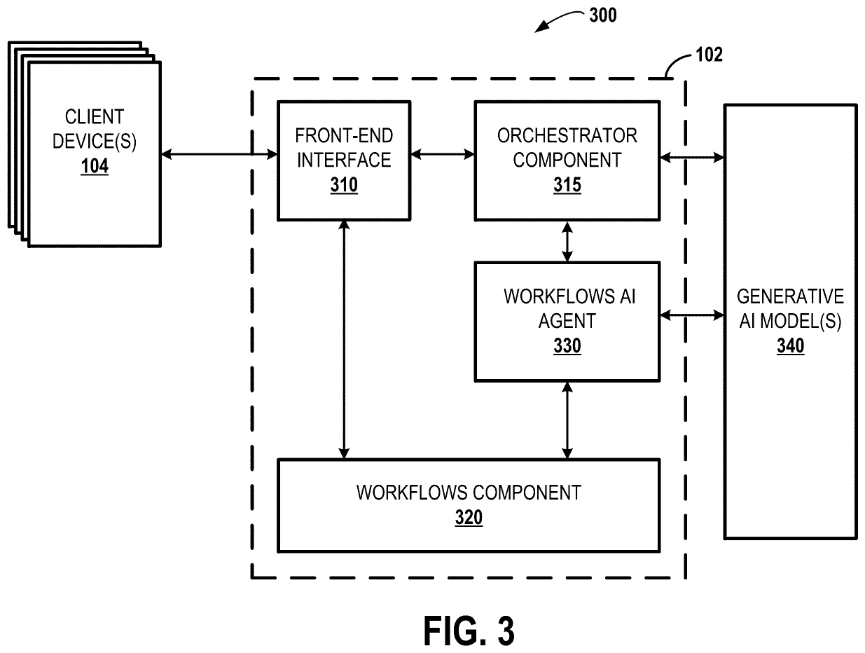

Turning now to FIG. 3, an example block diagram for an AI-based software architecture 300 that enables a user to control a construction management software application through input of natural-language and image-based requests is illustrated. In practice, the example AI-based software architecture 300 may be encoded in the form of program instructions that are executable by one or more processors of a computing platform, and for purposes of illustration, the AI-based software architecture 300 is described as being installed on and executed by the back-end computing platform 102 of FIG. 1, but it should be understood that the example AI-based software architecture 300 may be installed on and executed by any one or more computing platforms that are capable of performing the example operations of the AI-based software architecture 300. Further, it should be understood that the example AI-based software architecture 300 is merely described in this manner for the sake of clarity and explanation and that the example operations may be implemented in various other manners, including the possibility that operations may be added, removed, rearranged into different orders, combined into fewer blocks, and/or separated into additional blocks depending upon the particular example.

The AI-based software architecture 300 will be described below with reference to controlling a Workflows tool of a construction management software application, but it should be understood that the AI-based software architecture 300 could apply to controlling other software tools and/or functionalities of a construction management software application.

As shown in FIG. 3, the example AI-based software architecture 300 comprises a front-end interface 310, a back-end software component for the Workflows tool that is referred to herein as a workflows component 320, and a workflows AI agent 330, among other possible components that may be included in the example AI-based software architecture 300. Additionally, as shown in FIG. 3, the AI-based software architecture 300 may interface with client devices 104 running front-end software for the construction management software application, which may include front-end software for the disclosed software technology. Additionally yet, as shown in FIG. 3, the example AI-based software architecture 300 may interface with at least one generative AI model(s) 340, which may either be hosted on a separate computing system that is accessible over a network-based communication path (e.g., via an API or the like) or be hosted on the back-end computing platform 102. Each of these components will now be described in further detail.

To begin, a client device 104 runs the disclosed front-end software that generally functions to provide an input/output interface between a user of the client device 104 and the back-end computing platform 102 that hosts the construction management software application. At a high level, the disclosed front-end software may provide functionality for (i) presenting the user with an interface for inputting (a) natural-language requests for controlling the construction management software application and/or software tools thereof (e.g., the Workflows tool) and (b) image data that includes a graphical representation of a workflow and (ii) transmit natural-language requests and image data that are input by the user to the back-end computing platform 102. Optionally, the front-end software may provide functionality for one or both of (i) presenting the user with a user interface for inputting a request to initialize an initial workflow-template data object for a given workflow-template data object (and, in some such examples, this request may be provided by the user in the form of the natural-language request) and (ii) presenting the user with a user interface for inputting a natural-language request to update the given workflow-template data object, after the given workflow-template data object is created. Each of these functions may take any of various forms.

For instance, as one possibility, the functions of presenting the user interface for inputting natural-language requests for creating workflow-template data objects and inputting image data (plus, optionally, the functions for presenting the user with a user interface for inputting a request to initialize workflow-template data objects and/or presenting the user with a user interface for inputting natural-language requests to update the previously-created workflow-template data objects) may involve (i) receiving a communication from the back-end computing platform 102 that instructs the client device 104 to present the user with the user interface and (ii) thereafter presenting the user with the user interface (e.g., via a display screen controlled by the client device 104). In practice, this communication may take the form of one or more messages (e.g., one or more HTTP messages) that are sent over the communication path 106 between the back-end computing platform 102 and the client device 104 and, in at least some implementations, the communication may be sent via one or more APIs.

The function of presenting the user with the user interface may take various other forms as well.

With regards to inputting natural-language requests, the user interface may enable the user to input natural-language requests in any of various manners. For instance, as one possibility, a user may access and use the front-end software running on the client device 104 to input a text-based natural-language request and/or a voice-based natural-language request (e.g., via a chat interface or the like). The interface may enable the user to input natural-language requests in other manners as well.

Further yet, the interface for inputting natural-language requests may take any of various forms. For instance, the interface for inputting natural-language requests may comprise a GUI view that includes one or more input-control elements (e.g., a text box) that enable the user to input natural-language requests in a text format. In one example, the GUI view may comprise a chat interface that may be accessed within the GUI view, beside the GUI view, or overlaid on the GUI view. Additionally or alternatively, the interface for inputting natural-language requests may comprise an input-control element that enables a user to initiate a session for inputting natural-language requests in an audio format using an I/O component of the client device 104 that captures audio (e.g., a microphone). The interface for inputting natural-language request may take various other forms, as well.

Regarding inputting the image data, the interface for inputting natural-language request may further enable the user to input image data in any of various manners. For instance, the interface may comprise a GUI view that includes one or more input control elements (e.g., an uploader button that enables a user to select a file that includes image data, an input box that enables a user to directly add a file comprising image data within a chat interface for inputting natural-language requests along with image data, etc.). The interface may include various other features to enable a user to input image data and such features may take various other forms, as well.

After the client device 104 running the front-end software receives the natural-language request and the image data (and, optionally, requests to initialize an initial-template data object and/or natural-language requests for updating the workflow-template data object), it then transmits the natural-language request and image data (and, optionally, the request to initialize an initial workflow-template data object and/or natural-language request for updating the workflow-template data object) to the front-end interface 310. In practice, the client device 104 may encode the natural-language request and image data (and, optionally, the request to initialize an initial workflow-template data object and/or natural-language request for updating the workflow-template data object) into a communication that is sent to the back-end computing platform 102. This communication may take the form of one or more messages (e.g., one or more HTTP messages) that are sent over the communication path 106 between the client device 104 and the back-end computing platform 102, and in at least some implementations, the communication may be sent via one or more APIs.

The front-end interface 310 generally functions to interface with the client device(s) 104 running the front-end software for the construction management software application, so as to receive communications from the client devices 104 via the communication paths 106 and/or send communications to the client devices 104 via the communication paths 106. For instance, at a high level, the functionality performed by the front-end interface 310 in accordance with the present disclosure may involve (i) receiving, from the client device 104, (a) a natural-language request to create a workflow-template data object and (b) image data that includes a graphical representation of a workflow, (ii) passing the received natural-language request and image data to the orchestrator component 315, (iii) receiving a response comprising an indication of a response to the natural-language request based on the image data, and (iv) based on the response, causing the client device 104 to update a GUI being presented to the user to reflect creation (or updating) of a workflow-template data object (e.g., by presenting a visual representation of the workflow-template data object) and perhaps also to show a textual response to the user's the natural-language request (e.g., a description of what actions, if any, were performed based on the natural-language request).

In some examples, the functionality performed by the front-end interface 310 may further involve (i) receiving, from the client device 104, a request to initialize an initial workflow-template data object for a given workflow-template data object and (ii) causing the workflows component 320 to initialize the initial workflow-template data object. The initial workflow-template data object may comprise either (i) a pre-existing workflow-template data object (e.g., a workflow-template data object that is stored on data storage accessible by the construction management software application) or (ii) a new workflow-template data object (e.g., a “blank” workflow-template data object that is structured based on a workflow template schema, but does not yet include data within data fields defined by the workflow template schema). In some examples, causing the workflows component 320 to initialize the given workflow-template data object may comprise (i) passing the request to initialize the given workflow-template data object to the workflows component 320 and (ii) receiving a response from the workflows component 320 indicating initialization of the given workflow-template data object. As an alternative example, the natural-language request may comprise a request to either (i) create a new workflow-template data object or (ii) update a pre-existing workflow-template data object that is accessible via the workflows component 320—in such examples, the front-end interface 310 may cause the workflows component 320 to initialize an initial workflow-template data object for the given workflow-template data object by: (i) passing the natural-language request to the workflows AI agent 330 (e.g., via passing the natural-language request through the orchestrator component 315) and, ultimately, (ii) receiving a response from the workflows component 320 indicating initialization of the initial workflow-template data object.

The natural-language request that is received by the front-end interface 310 may take any of various forms. For instance, the natural-language request may comprise a request to, based on (at least) image data that includes a graphical representation of a workflow, create or update a workflow-template data object related to the workflow. In another example, the natural-language request may comprise a request to alter a previously created workflow-template data object.

The image data may be input to the front-end interface 310 either as (i) a data object (containing the image data) received from the client device 104 (e.g., taking the form of one or more messages, such as one or more HTTP messages, that are sent over the communication path 106 between the back-end computing platform 102 and the client device 104) or (ii) received via the computing platform 102 accessing the input data based on instructions that are provided as the image data input (e.g., a file-path to the data object (containing the image data) that accesses the data object from data storage that is accessible by the computing platform 102, a hyper-link to a cloud-storage address wherein the data object (containing the image data) is stored, etc.).

As discussed above, the image data received by the front-end interface 310 may comprise data that includes a graphical representation of a workflow. For example, the graphical representation of a workflow may comprise image data representative of a flowchart that is associated with a workflow. Image data that is representative of a flowchart may take any of various forms, such as screen-shots of flowcharts created in other software applications, image files having representations of a flowcharts therein, photographs of handwritten flowcharts, data objects generated by (and/or used by) other software applications that are capable of generating flowcharts (e.g., Microsoft Visio data objects, Microsoft PowerPoint data objects, Google Slides data objects, etc.), portable document format (“.pdf”) documents, etc.

The image data received by front-end interface 310 may take various other forms, as well.

As yet another possibility, in one example, front-end interface 310 may receive both natural-language instructions and image data, from a common source (e.g., a data object that comprises both natural-language instructions and image data that includes a graphical representation of a workflow). In particular, such a data object that comprises a common source for natural-language instructions and image data may comprise image or video data that includes (i) image data that depicts a visual representation of a flowchart and (ii) one or both of (a) written text within the image or video data that comprise natural-language describing the flowchart and/or instructions related to a workflow represented by the flowchart or (b) natural language in the form of (audio-based) spoken word describing the flowchart and/or instructions related to a workflow represented by the flowchart. In this example, the natural-language instructions may be independent of a natural-language request to create a workflow-template data object (e.g., the natural-language information only comprises natural-language describing the flowchart) or the natural-language instructions may include the request to create the workflow-template data object (e.g., the natural-language information comprises one or both of natural-language describing the flowchart or natural-language comprising the natural-language request to create the workflow-template data object). Input that combines both natural-language instructions and image data, which includes a graphical representation of a workflow, may take various other forms, as well.

Further, the function of causing the client device 104 to update a GUI being presented to the user to reflect creation or updating of a workflow-template data object (and perhaps also to show a textual response to the user's the natural-language request), may take any of various forms. For instance, as one possibility, the function of causing the client device 104 to update a GUI being presented to the user to reflect creation or updating of a workflow-template data object (and perhaps also to show a textual response to the user's the natural-language request) may involve (i) the back-end computing platform 102 transmitting a communication to the client device 104 that instructs the client device 104 update a GUI being presented to the user to reflect creation or updating of a workflow-template data object (and perhaps also to show a textual response to the user's natural-language request), (ii) the client device 104 receiving the communication, and (iii) the client device 104 thereafter presenting the user with an updated GUI to reflect creation or updating of a workflow-template data object, and perhaps also to show a textual response to the user's natural-language request (e.g., via a display screen controlled by the client device 104). In practice, this communication may take the form of one or more messages (e.g., one or more HTTP messages) that are sent over the communication path 106 between the back-end computing platform 102 and the client device 104 and, in at least some implementations, the communication may be sent via one or more APIs.

The front-end interface 310 may perform other functions as well, including but not limited to the possibility that the front-end interface 310 may exchange other types of communications with the client devices 104 that do not involve natural-language queries and/or image data.

Further, in other implementations, the front-end interface 310 may be configured to pass requests to and/or receive responses from other components of the AI-based software architecture 300, such as such as the orchestrator component 315 that is configured to evaluate and route incoming requests to AI agents and then relay responses from the AI agents back to the front-end interface 310.

As noted above, the workflows component 320 comprises the back-end software for the Workflows tool (e.g., the Workflows tool discussed above and with respect to FIGS. 2A-2B). In this respect, the workflows component 320 may carry out the back-end functionality for the workflows tool, including but not limited to back-end functionality related to creating, storing, presenting, and/or updating workflow-template data objects. Further, in accordance with the present disclosure, the workflows component 320 may additionally function to (i) receive workflow-template data objects from the workflows AI agent 330 (e.g., via an API or the like) and (ii) perform one or more actions related to the received workflow-template data object (e.g., generating visual representations of the received workflow-template data objects, initiating a workflow instance of a workflow template represented by the received workflow-template data objects, etc.). In some examples, the workflows component 320 may further function to initialize an initial workflow-template data object to be utilized in creating or updating a given workflow-template data object (e.g., in response to a request from one of the front-end interface 310 or the workflows AI agent 330).

The functionality of the workflows component 320 may take various other forms as well.

As noted above, after the natural-language request is received by the front-end interface 310, the front-end interface 310 may pass the natural-language request to the orchestrator component 315, which may generally function to (i) receive the natural-language request from the front-end interface 310, (ii) identify at least one AI agent (e.g., the workflows AI agent 330 or another AI agent) that is to be utilized to handle the natural-language request and thereby determine where to route the natural-language request, (iii) route the natural-language request to the identified at least one AI agent for handling, (iv) receive a response from the identified at least one AI agent, and (v) pass the response back to the front-end interface 310.

At a high level, the function of identifying the at least one AI agent (e.g., the workflows AI agent 330 or another AI agent) that is to be utilized to handle the natural-language request may involve determining which of at least one AI agent is best suited to handle the natural-language request. The orchestrator component 315 may make this identification in any of various manners.

As one possibility, the orchestrator component 315 may identify the at least one AI agent using the generative AI model(s) 340. In this respect, the orchestrator component 315 may (i) generate a prompt comprising a request to determine which of the at least one AI agents is best suited to handle the natural-language request, (ii) pass the prompt as input to the generative AI model(s) 340, (iii) receive a response from the generative AI model(s) 340 comprising a prediction of which of the at least one AI agents is best suited to handle the natural-language request, and then (iv) use that prediction as a basis for identifying the at least one AI agent that is to be utilized to handle the incoming request.

As one example, consider that the natural-language request is a natural-language request to create or update a workflow-template data object. In this example, the orchestrator component 315 may function to (i) generate a prompt comprising a request to determine which of the at least one AI agents (e.g., the workflows AI agent 330 or another AI agent) is best suited to handle the natural-language request to create or update a workflow-template data object, (ii) pass the prompt as input to an AI model (e.g., the generative AI model(s) 340), (iii) receive a response from the AI model comprising a prediction that the workflows AI agent 330 is best suited to handle the natural-language request (which may be a prediction that the workflows AI agent 330 is best suited to handle the natural-language request because the workflows AI agent 330 is preconfigured for transforming a user's natural-language request and image data (that includes a graphical representation of a workflow) into a workflow-template data object), and then (iv) use that prediction as a basis for identifying that the workflows AI agent 330 is to be utilized to handle the incoming request.

As another possibility, the orchestrator component 315 may identify the at least one AI agent using a different type of model, such as a discriminative AI model (e.g., a decision-tree model, neural-network-based model, a regression model, etc.) or a rule-based model. In this respect, the orchestrator component 315 may (i) generate a set of feature data based on the incoming request, (ii) pass the set of feature data as input to the discriminative AI or rule-based model, (iii) receive the output of discriminative AI or rule-based model, which may comprise a prediction of which of the at least one AI agents is best suited to handle the natural-language request, and then (iv) use the output of the discriminative AI rule-based model as a basis for identifying the at least one AI agent that is to be utilized to handle the natural-language request.

The function of identifying the at least one AI agent that is to be utilized to handle the incoming request may also take other forms.

As noted above, if orchestrator component 315 identifies that the natural-language request is a natural-language request to create or update a workflow-template data object, the orchestrator component 315 may pass the natural-language request and the image data to the workflows AI agent 330. In accordance with the present disclosure, the workflows AI agent 330 may take the form of a software component that provides an interface to a respective AI model (e.g., the generative AI model(s) 340) and is preconfigured to perform particular AI-based functionality in order to accomplish a respective type of task that is preconfigured for the workflows AI agent 330—which in this case involves AI-based functionality for transforming a user's natural-language request and image data (that includes a graphical representation of a workflow) into a workflow-template data object. In some implementations, the workflows AI agent 330 may be implemented in the form of a discrete executable software component, which is how the workflows AI agent 330 is shown in FIG. 3 and described below for purposes of illustration. However, it should be understood that in other implementations, the workflows AI agent 330 may be implemented in the form of a discrete configuration file (e.g., a YAML file) that, when loaded and executed by a centralized execution engine (e.g., an agent executor), causes the centralized execution engine to perform the functions for the AI agent. The workflows AI agent 330 may take other forms as well.

At a high level, the AI-based functionality of the workflows AI agent 330 may involve (i) receiving, from the orchestrator component 315, a natural-language request to create or update a given workflow-template data object and image data that includes a graphical representation of a given workflow, (ii) based on the natural-language request and the image data, generating a prompt for the generative AI model(s) 340 to create or update the given workflow-template data object, (iii) passing the prompt to the generative AI model(s) 340, (iv) receiving a response from the generative AI model that comprises the given workflow-template data object, and (v) passing the workflow-template data object to the workflows component 320 and thereby enabling a user to interact with the workflow-template data object via the workflows component 320. Each of these functions may take any of various forms.

To begin, the function of receiving the natural-language request to create or update a workflow-template data object and image data (that includes a graphical representation of a workflow) from the orchestrator component 315 may involve receiving the natural-language request and image data from the orchestrator component 315 via an API, a messaging queue or bus, or some other form of inter-process communication.

The functionality for, based on the natural-language request and the image data, generating a prompt for the generative AI model(s) 340 may take any of various forms. For instance, the prompt for the generative AI model that is generated by the workflows AI agent 330 may comprise (i) the natural-language request, (ii) the image data, (iii) a workflow template schema that defines a data structure for workflow-template data objects, and (iv) a request to create or modify a workflow-template data object. The data structure defined by the workflow template schema may comprise (i) one or more data fields that define attributes of a workflow template that is represented by a workflow-template data object that is to be created, in response to the prompt, and (ii) an ordering of the one or more data fields that forms the data structure.

In order to populate the one or more data fields of the workflow template schema for the given workflow-template data object, in some examples, the prompt for the generative AI model that is generated by the workflows AI agent 330 may further comprise (i) a request to extract unstructured data related to the given workflow-template data object from the natural-language request and/or the image data and (ii) based on the extracted unstructured data and the workflow template schema, generate data in the form of the workflow template schema and thereby create or update the given workflow-template data object.

The extracted unstructured data may take any of various forms of data that can be used to define attributes of a workflow-template to be created based on the extracted unstructured data. For example, the unstructured data may be data related to steps (e.g., response steps, condition steps, end steps, etc.) that are to be included in a workflow-template data object that is, at least in part, based on the image data. Such extracted, unstructured data may include data for various data fields that are grouped for a given step of the workflow-template data object such as, but not limited to, data for a name data field for the given step, data indicative of conditions based on a response to the given step, data indicative of a status of the given step, data indicative of a type of the given step, data indicative of timeline information for the given step, data indicative of an assignee (and/or assignee role) of the given step, etc. Further still, the extracted unstructured data may include one or both of (i) an indication of a construction-task type with which the workflow-template data object to-be-created will be associated or (ii) an indication of a software tool of the construction management software application with which the workflow-template data object to-be-created will interact with.

In yet another example, the prompt for the generative AI model that is generated by the workflows AI agent may further comprise example training data that comprises a set of pairs of (i) image datasets each representative a respective workflow template and (ii) workflow-template data objects (in accordance with the workflow template schema) that are each representative of the respective workflow template. The training data, thus, may comprise a set of labelled examples of conversions from image data representative of a respective workflow to a workflow-template data object representative of the respective workflow. By passing the training data to the generative AI model(s) 340 as part of the prompt, the workflows AI agent 330 may “train” the generative AI model 340 to accomplish the task of converting various aspects of the image data for inclusion in a workflow-template data object. Such training may take any of various forms, such as, but not limited to a “few-shot learning” approach to training the generative AI model(s) 340.

In some examples, the prompt for the generative AI model that is generated by the workflows AI agent 330 may further comprise an initial workflow-template data object that (i) complies with the workflow template schema and (ii) serves as a basis for the given workflow-template data object. In an example wherein the natural-language request comprises a natural-language request to create a new workflow-template data object, the initial workflow-template data object of the prompt may be a blank workflow-template data object that has been previously initialized by the workflows component 320 (e.g., in response to a request provided to the workflows component 320 by either the front-end interface 310 or the workflows AI agent 330). Alternatively, in an example wherein the natural-language request comprises a natural-language request to update a workflow-template data object, the initial workflow-template data object of the prompt may be a pre-existing workflow-template data object that has been previously initialized by the workflows component 320 (e.g., in response to a request provided to the workflows component 320 by either the front-end interface 310 or the workflows AI agent 330)

In the example wherein the workflows component 320 receives the request to initialize the initial workflow-template data object from the workflows AI agent 330, the workflows AI agent 330 may further function to (i) extract, from the natural-language request, a request to initialize the initial workflow-template data object, (ii) pass the request to initialize the initial workflow-template data object to the workflow component 320, and (iii) receive the initial workflow-template data object from the workflow component 320. In some such examples, extracting the request to initialize the initial workflow-template data object may comprise determining the request to initialize the initial workflow-template data object using the generative AI model(s) 340.

In yet another example, the functionality for, based on the natural-language request and the image data, generating a prompt for the generative AI model(s) 340 may comprise (i) generating a first prompt for a first generative AI model (of the generative AI model(s) 340) and (ii) generating a second prompt for a second generative AI model (of the generative AI model(s) 340). The first prompt may comprise (a) the image data and (b) a request to extract unstructured data related to workflows from the image data. The second prompt may comprise (a) the request to generate the given workflow-template data object and (b) the extracted unstructured data.

Further still, in some examples, the prompt for the generative AI model(s) 340 may include structured data that is (i) related to construction projects and/or workflows carried out by users of the construction management software application and (ii) may provide context and/or background for the generative AI model(s) 340, when generating workflow-template data objects. Such structured data may be received by and/or accessed by the workflows AI agent 330 in any of various ways. For example, the structured data (or an indication of a location of the structured data) may be input to the AI-based software architecture 300 by a user (e.g., via a user of a client device 104). Alternatively, the workflows AI agent 330 may automatically access (from data storage) the structured data, for inclusion in the prompt, based on an evaluation of the natural-language request to generate the workflow-template data object.

Such structured data may take any of various forms. For example, the structured data may include information that is organized into rows and columns of a spreadsheet or database, or any other format that adheres to some predefined schema. This type of structured data may include various information related to a construction project task, such as steps that are to be completed, dependencies between steps, parties to whom the steps should be assigned, etc. However, structured data in this form is not functional as a workflow-template data object within a construction management software application. Similar to an image of a workflow that might include the same information, this type of structured data would traditionally need to be manually transferred into a workflows tool by a user of the construction management software application, (e.g., using a Workflows GUI tool as discussed above) to generate a new workflow-template data object. Accordingly, the AI-based software architecture discussed herein provides significant benefits when the underlying workflow information takes the form of either structured or unstructured data.

Returning again to the functionality of the workflows AI agent 330, the AI agent's functions of passing the generated prompt to the generative AI model(s) 340 and receiving the response from the generative AI model(s) 340 may take any of various forms, which may depend in part on where the generative AI model(s) 340 is hosted. For instance, in an implementation where the generative AI model(s) 340 is hosted on a separate computing platform from the back-end computing platform 102, these functions may involve sending the generated prompt to the generative AI model(s) 340 over an external network-based communication path (e.g., via an API or the like) and then receiving the response from the generative AI model(s) 340 over the external network-based communication path. Alternatively, in an implementation where the generative AI model(s) 340 is hosted on the back-end computing platform 102, these functions may involve sending the generated prompt via an internal communication path (e.g., an API, a messaging queue or bus, or some other form of inter-process communication) and then receiving the response from the generative AI model(s) 340 over the internal communication path.

In the example wherein generating a prompt for the generative AI model(s) 340 comprises generating a first prompt for a first generative AI model and generating a second prompt for a second generative AI model, passing the generated prompt to the generative AI model(s) 340 may comprise passing the first prompt to the first generative AI model and passing the second prompt to the second AI model. Further, in such an example, receiving the response from the generative AI model(s) 340 may comprise receiving the extracted unstructured data from the first generative AI model and receiving the given workflow-template data object from the second generative AI model.

Alternatively, in some examples the generative AI model(s) 340 may include a single generative AI model (e.g., a multimodal generative AI model) that is capable of providing the functionality to (i) extract unstructured data from the image data and (ii) based on the unstructured data, generate a workflow-template data object. In such an example the prompt may comprise a single prompt that includes, at least, the image data and the request to generate the workflow-template data object.

The functions that the workflows AI agent 330 performs to pass the generated prompt to the generative AI model(s) 340 and to receive the response from the generative AI model(s) 340 may take other forms as well.

The functionality for passing the workflow-template data object to the workflows component 320 (thereby enabling a user to interact with the workflow-template data object via the workflows component 320) may take any of various forms. This functionality may involve sending the workflow-template data object to the workflows component 320 via an API, a messaging queue or bus, or some other form of inter-process communication.

Further still, in some examples, the workflows AI agent 330 may further function to update a previously-created workflow-template data object. In such an example, the workflows AI agent 330 may further function to: (i) receive, from the orchestrator component 315 (as received by the orchestrator component 315 from the front-end interface 310) a natural-language request to update the given workflow-template data object (e.g., a workflow-template data object that was previously created via the AI-based software architecture disclosed herein), (ii) based on the given workflow-template data object and the natural-language request to update the given workflow-template data object, generate a prompt for the generative AI model(s) 340 to update the given workflow-template data object, (iii) pass the prompt to the generative AI model(s) 340, (iv) receive a response from the generative AI model that comprises an updated workflow-template data object (e.g., the given workflow-template data object as updated in response to the natural-language request), and (v) pass the updated workflow-template data object to the workflows component 320 and thereby enable a user to interact with the updated workflow-template data object via the workflows component 320. Each of these functions may take a similar form to the previously discussed functionality of the workflows AI agent 330 for creating workflow-template data objects; however, each of these functions may take any of various other forms.

In some examples, the workflows AI agent 330 may automatically repeat the aforementioned functionality for (i) generating a prompt for the generative AI model(s) 340, (ii) passing the generated prompt to the generative AI model(s) 340, and (iii) receiving a response from the generative AI model(s) 340 that comprises a generated workflow-template data object. For example, the workflows AI agent 330 may be configured to evaluate a received workflow-template data object to determine if the received workflow-template data object satisfies the natural language request for generating the workflow-template data object. In such an example, if the received workflow-template data object satisfies the natural-language request, then the workflows AI agent 330 passes the workflow-template data object to the workflows component 320; otherwise, if the received workflow-template data object does not satisfy the natural-language request, the workflows AI agent 330 may then (i) generate a prompt for the generative AI model(s) 340 to update the workflow-template data object, (ii) pass the prompt to the generative AI model(s) 340, and (iii) thereafter receive an updated workflow-template data object.

Such updating of the workflow-template data object may be performed any number of times until the workflows AI agent 330 determines that the workflow-template data object satisfies the natural-language request.

Further, in such examples, the prompt to update the workflow-template data object may comprise instructions, generated by the workflows AI agent 330, for updating the workflow-template data object and such instructions may be based on the evaluation of the workflow-template data object. For example, the instructions may comprise one or more of instructions to alter various steps of the workflow-template data object, instructions to re-order steps of the workflow-template data object, instructions to add steps to the workflow-template data object and/or remove steps from the workflow-template data object, etc. The instructions to update the workflow-template data object may take various other forms, as well.

Functionality of the workflows AI agent 330 for automatically updating a workflow-template data object may take the form of an iterative process and/or a loop-based updating process. The functionality of the workflows AI agent 330 for automatically updating a workflow-template data object may take various other forms as well.

In general, the functionality of the workflows AI agent 330 may take various other forms as well.

Turning next to the generative AI model(s) 340, in line with the discussion above, the generative AI model(s) 340 may generally function to (i) receive a prompt comprising a request to perform a task, (ii) perform the task, (iii) generate a response to the request that indicates the results of performing the task, and (iv) return the response to the software component from which the prompt was received.

For instance, as discussed above, the generative AI model(s) 340 may (i) receive the prompt from the workflows AI agent 330 comprising the request to create or update a workflow-template data object and image data that includes a graphical representation of a workflow, (ii) generate a response comprising a workflow-template data object, as generated by the generative AI model(s) 340 in response to the prompt, and (iii) return the response to the Workflows AI agent 330.

In this respect, the generative AI model's functions of creating or updating a workflow-template data object may involve (i) analyzing the natural-language request to determine an intent of natural-language request, (ii) utilize one or more image processing techniques to extract unstructured data from the image data, (iii) based on the intent of the natural-language request and the extracted unstructured data, determine values for one or more data fields according to a workflow template schema for a workflow-template data object to-be-created (e.g., based on, for example, a workflow template schema that is either (a) included in the prompt or (b) known by the generative AI model(s) 340), (iv) based on the determined values for the one or more data fields and the workflow template schema, generate the workflow-template data object, and (v) pass a response to the workflows AI agent that comprises the generated workflow-template data object.

Utilizing one or more image processing techniques, by the generative AI model(s) 340, to extract unstructured data from the image data may take any of various forms. For example, the one or more image processing techniques utilized by the generative AI model(s) 340 may comprise text extraction techniques (e.g., various optical character recognition (“OCR”) technologies) for extracting text data from the image data and/or various computer vision techniques for detecting specific data/images within the image data (e.g., image classification techniques, object detection techniques, image segmentation techniques, feature extraction techniques, etc.). The one or more image processing techniques may take various other forms, as well.

The unstructured data may be extracted (e.g., via use of one or more of the aforementioned techniques) based on visual characteristics that are extracted during this process. For example, data related to steps (e.g., response steps, condition steps, end steps, etc.) that are to be included in a workflow-template data may be determined based on contextual data detected in the image data (e.g., shapes of steps in a flowchart, ordering of steps in a flowchart, etc.). Further still, data for a name data field for the given step may be extracted based on text extracted proximate to or within a visual feature indicating a step, data indicative of conditions based on a response to the given step may be extracted based on contextual data (text, image features, ordering of image features) detected in the image data, data indicative of an assignee (and/or assignee role) of the given step may be extracted based on text proximate to a given step, etc.

Further, as discussed above, in some examples, the prompt may comprise example training data that comprises a set of pairs of (i) image datasets each representative a respective workflow template and (ii) workflow-template data objects (in accordance with the workflow template schema) that are each representative of the respective workflow template. In some such examples, in addition to (or as an alternative to) utilizing the example training data to “train” the generative AI model(s) 340, the generative AI model(s) 340 may utilize the training data as a searchable database, from which the generative AI model(s) 340 may compare features detected in the input image data to the training dataset to thereby extract examples based on similarities between the detected features and image datasets of the training dataset. Such searching of a searchable database, by the generative AI model(s) 340, may take any of various forms, such as, but not limited to, retrieval-augmented generation (RAG), which may utilize the training data as an external data source, from which the generative AI model(s) 340 may retrieve relevant information, when extracting the unstructured data.

The generative AI model(s) 340 may receive various other types of requests and perform various other tasks as well.

The generative AI model(s) 340 may take any of various forms. For instance, the generative AI model(s) 340 may be a transformer-based model (e.g., a language model such as a large language model (LLM) and/or a multimodal model such as a vision-language model (VLM)), a diffusion model, a model based on a generational adversarial network (GAN), and/or a model based on a variational autoencoders (VAEs), among other possible types of generative AI models. Further, the generative AI model(s) 340 may comprise a pre-trained generative AI model (e.g., an “off-the-shelf” generative AI model) that may or may not be further trained (e.g., via fine tuning, few-shot learning, or the like), or may comprise a generative AI model that is trained in the first instance to perform the tasks described herein, among other possibilities. Some representative examples of pre-trained generative AI models include a generative pre-trained transformer (GPT) type of generative AI model, a bidirectional encoder representations from transformers (BERT) type of generative AI model, a bidirectional auto-regressive transformer (BART) type of generative AI model, a text-to-text transfer transformer (T5) type of generative AI model, a pre-training with extracted gap sentences for abstractive summarization (PEGASUS) type of generative AI model, a large language model meta AI (LlaMA) type of generative AI model, a Phi-2 or Phi-3 type of generative AI model, a PaliGemma type of generative AI model, and/or a Florence-2 type of generative AI model, among other examples. The generative AI model(s) 340 may take other forms as well.

As discussed above, in some implementations, the generative AI model(s) 340 may be hosted on a computing platform that is separate from the back-end computing platform 102, in which case the generative AI model(s) 340 may be accessed over a network-based communication path (e.g., via an API or the like), while in other implementations, the generative AI model(s) 340 may be hosted on the back-end computing platform 102.

It should also be understood that the components of the example AI-based software architecture 300 could interface with multiple different generative AI models 340. For instance, as one possibility, different components of the example AI-based software architecture 300 could be configured to interface with multiple different generative AI models 340, which could be of the same type or of different types. As another possibility, the workflows AI agent 330 could be configured to interface with multiple different generative AI models 340, which could be of the same type or of different types. Other configurations are possible as well.

The example AI-based software architecture 300 may take various other forms as well. For instance, as one possibility, the example AI-based software architecture 300 may include other components that are not shown or described above but may nevertheless facilitate the functionality disclosed herein. As another possibility, certain of the components shown and described above could be combined together or separated out into multiple sub-components. For example, in an implementation the workflows AI agent 330 is implemented in the form of a configuration file that is executed by a centralized execution engine, the centralized execution engine could be combined together with the orchestrator component 315. As another example, the front-end interface 310 could be combined together with the orchestrator component 315. Other examples are possible as well. As yet another possibility, certain of the components shown and described above may perform additional or different functionality from what is described above. For example, in addition to the functionality described above, the orchestrator component 315 may function to decompose the incoming request into a set of subqueries that are to be handled by the workflows AI agent 330 (and/or some other AI agent) so as to facilitate the task of interpreting and responding to the incoming request. Other variations of the example AI-based software architecture 300 are possible as well.

In line with the discussion above, it is also possible that the front-end interface 310 and the orchestrator component 315 of the example AI-based software architecture 300 could receive other types of incoming requests related to a software tool that should be routed to and handled by a different software component from the workflows AI agent 330. Some illustrative examples of these other type of requests will now be described below with reference to the Workflows tool, but it should be understood that the requests could be related to other software tools and/or take other forms as well.

Other examples of AI agents (and/or other software components) for performing additional functionality related to the Workflows-tool functions described herein are possible as well.

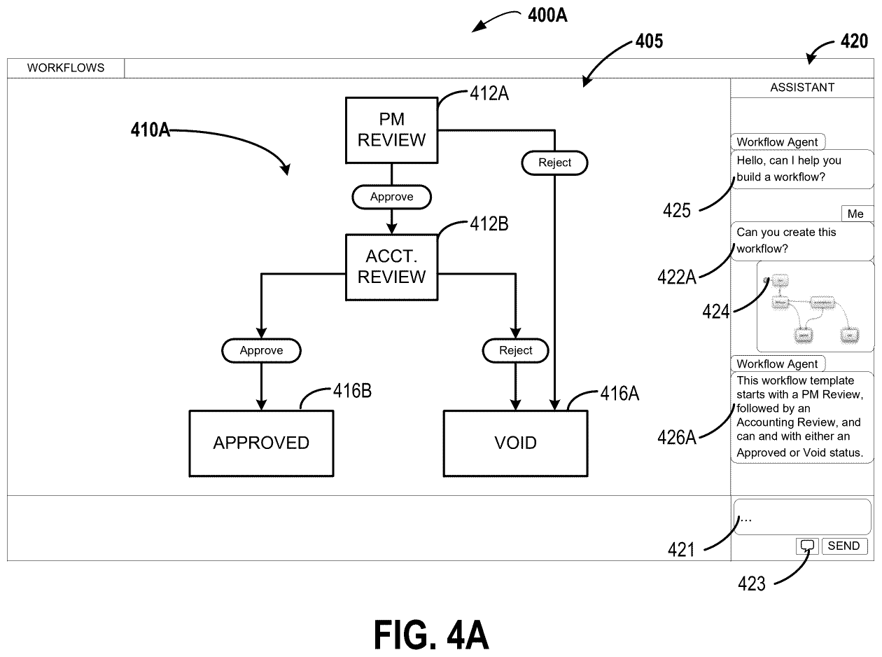

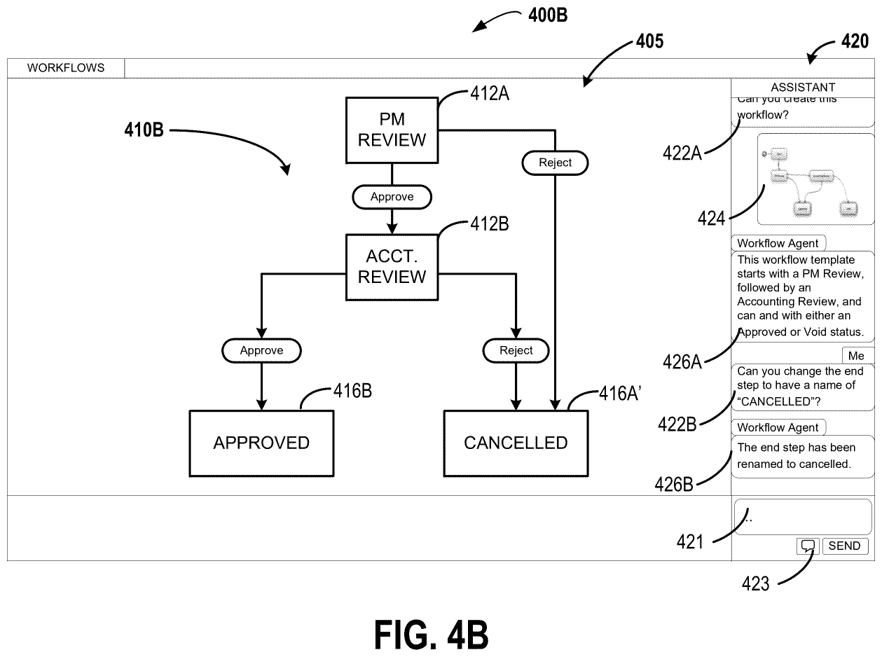

FIG. 4A shows an example first GUI view 400A comprising an example workspace 405 output by the construction management software application (e.g., using a Workflows tool) and presented to the user of a client device 104 by way of front-end software. As shown, the workspace 405 is overlaid with a chat interface 420 (which may be associated with an AI-based digital assistant of the construction management software platform).

As further shown, the chat interface 420 may comprise a text box 421 that enables the user to input a natural-language request in text format. In some examples, the chat interface may comprise an input-control element 423 that enables a user to initiate a session for inputting a natural-language request in an audio format using an I/O component of the client device 104 that captures audio. As illustrated, the chat interface 420 may present the user with a message 425 that solicits the user to provide input to the chat interface 420 that takes the form of a natural-language request (e.g., as text or voice input). Further still, the chat interface 420 may additionally comprise one or both of (i) another input control element (e.g., an uploader) that enables a user to upload image data or (ii) functionality for dragging image data into the chat interface 420 (e.g., via dragging a file comprising image data into the text box 421).

As illustrated, a user of the client device has responded to the message 425 with a natural-language request 422A (“Can you create this workflow?”) and image data 424 that includes a graphical representation of a workflow (e.g., a flowchart). In response to the natural-language request 422A and the image data 424, the disclosed AI-based software architecture may then generate a workflow-template data object that is represented in the first GUI view by the workflow-template flowchart 410A. As illustrated via the workflow-template flowchart 410A, the workflow-template data object may comprise a first response step 412A (Project Manager (“PM”) Review), a second response step 412B (Accounting (“ACCT.” Review), a first end step 416A (“Cancelled”), and a second end step 416B (“Approved”). The workflow-template flowchart 410A, as presented in the workspace 405, is generated in this visual form, such that a user of the client device 104 may then interact with the workflow-template data object (e.g., via interacting with the workflow-template flowchart 410A) in any of various ways (e.g., instantiating an instance of a workflow based on the workflow-template data object, viewing the workflow-template flowchart 410A as a representation of the workflow-template data object, editing the workflow-template data object by way of providing input via altering the workflow-template flowchart 410A, etc.).

One way that a user may interact with the workflow-template data object is to utilize the AI-based software architecture disclosed herein (via, for example, the chat interface 420) to update the workflow-template data object (that is represented, visually, by the workflow-template flowchart 410). To that end, FIG. 4B shows an example second GUI view 400B, which is an updated version of the first GUI view 400A of FIG. 4A. The second GUI view 400B comprises an updated workflow-template flowchart 410B within the workspace 205 that is an updated version of the workflow-template flowchart 410A of FIG. 4A. The workflow-template flowchart 410B has been updated by the workflows AI agent 330 passing an updated version of the workflow-template data object to the Workflows tool, by way of the disclosed AI-based software architecture 300 carrying out at least some of the functionality disclosed herein.

The workflow-template flowchart 410A is updated to the updated workflow-template flowchart 410B in response to a second natural-language request 422B (“Can you change the end step to have a name of ‘CANCELLED’?”). The second natural-language request 426B may have been input by a user using the chat interface (e.g., as text input to the text box 421 or audio input via the input-control element 423). For example and as illustrated, in response to the natural-language request 422B, the disclosed AI-based software architecture 300 may now have updated the text content of the end step 416 from “VOID” (end step 416, FIG. 4A), to “CANCELLED” (end step 416A′, FIG. 4B).

Updating the workflow-template flowchart 410A to the updated workflow-template flowchart 410B may occur because the back-end computing platform 102 carried out at least some of the disclosed functionality of the AI-based software architecture 300, discussed above.

Output in response to the natural-language requests 422A, 422B may take any of various other forms in addition to the visual representation illustrated by the GUI views 400A, 400B. For example, output in response to the natural-language requests may include a natural language response 426A that explains the actions performed (e.g., “The workflow template starts with a PM Review, followed by an Accounting Review, and can end with either an approved or void status,” “The end step has been renamed to cancelled,” etc.). Further, output in response to the natural-language requests 422A, 422B may take any of various other forms.

Further still, the GUI views 400A, 400B may include an interface of an AI assistant of the construction management software platform. For example, the chat interface 420 may be a chat interface for an AI assistant of the construction management software platform. The AI assistant may utilize the AI-based software architecture 300 to create or update workflow-template data objects.

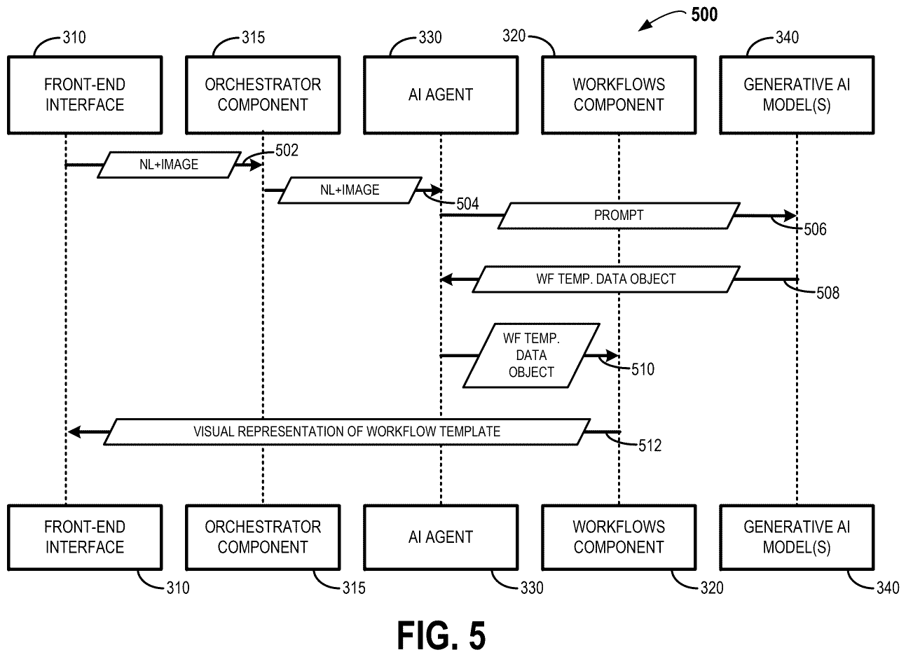

Turning now to FIG. 5, a communication diagram 500 that depicts communications between components shown in FIG. 3 is shown in accordance with the functionality disclosed herein. The communication diagram 500 illustrates the respective source and respective destination of each communication depicted therein. In addition, the communication diagram 500 illustrates one possible sequence of the communications shown. However, some of the communications shown may occur concurrently and/or in sequences that differ from the sequence shown. Furthermore, in some implementations, two or more of the communications shown may be combined into a single communication and/or a single communication may be divided into multiple communications. Also, in some implementations, the disclosed functionality may involve additional communications that are not depicted in the communication diagram 500.

Prior to arrow 502, a client device 104 running the front-end software for the construction management software application sends a natural-language request and image data, which are subsequently received by the front-end interface 310. The natural-language request and image data that are received by the front-end interface 310 may each take any of the various forms discussed above, and for purposes of this example, will be assumed to be a request for creating or updating a workflow-template data object.

At arrow 502, the front-end interface 310 sends the natural-language request and image data, which are received by the orchestrator component 315. The natural-language request and/or the image data that are received by the orchestrator component 315 may each take any of the various forms discussed above.

At arrow 504, the orchestrator component 315 passes the received natural-language request and image data to the workflows AI agent 330. After receiving the incoming natural-language request and image data, the workflows AI agent 330 generates a prompt for the generative AI model(s) 340 that comprises a request to create or update a workflow-template data object.

The prompt for the generative AI model that is generated by the Workflows AI agent 330 may comprise (i) the natural-language request, (ii) the image data, and (iii) a workflow template schema that defines a data structure for workflow-template data objects. In some examples, the prompt may further comprise (i) a request to extract unstructured data related to the given workflow-template data object from the natural-language request and/or the image data and (ii) based on the extracted unstructured data and the workflow template schema, create or update the given workflow-template data object. In some examples, the prompt for the generative AI model that is generated by the workflows AI agent may further comprise example training data that comprises a set of pairs of (i) image datasets each representative a respective workflow template and (ii) workflow-template data objects (in accordance with the workflow template schema) that are each representative of the respective workflow template.

At arrow 506, the Workflows AI agent 330 passes the prompt to the generative AI model(s) 340 as input. After receiving the prompt, the generative AI model(s) 340 may generate a response that comprises a workflow-template data object.

At arrow 508, the workflows AI agent 330 receives the response that comprises the workflow-template data object from the generative AI model(s) 340.

At arrow 510, the Workflows AI agent 330 passes the workflow template data object to the workflows component 320, which may enable the workflows component 320 to perform one or more actions requested by the user.

At arrow 512, the workflows component 320 may (i) generate an indication (e.g., a GUI view) of the created or updated workflow-template data object and (ii) send the indication of the created or updated workflow-template data object to front-end interface 310 along with an instruction to present the indication of the created or updated workflow-template data object as a visual representation to the user. The indication of the created or updated workflow-template data object and the instruction to present the indication of the created or updated workflow-template data object to the user may then be transmitted to a client device 104 and then presented as a visual representation of the workflow-template data object to the user.

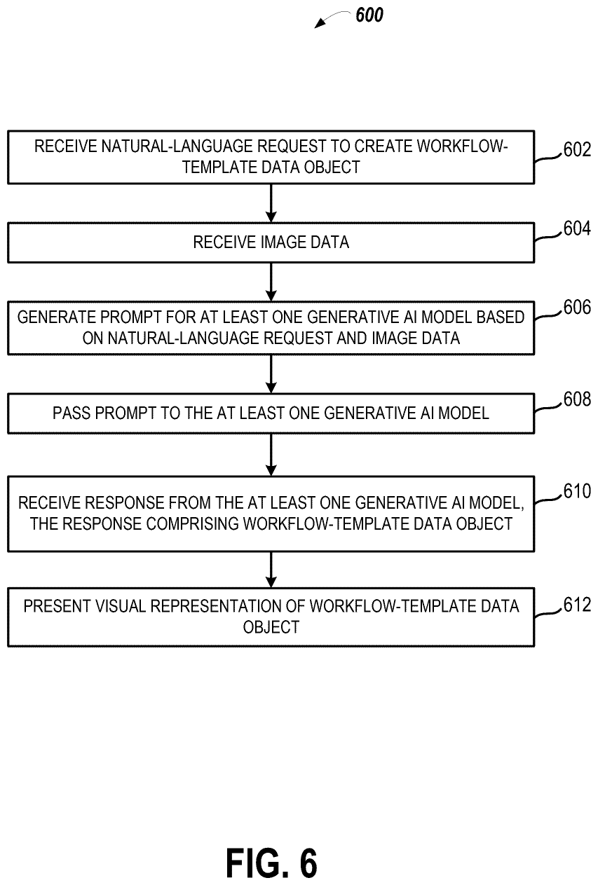

Turning to FIG. 6, example functionality 600 is illustrated in the form of a flow diagram. For purposes of illustration, the example functionality 600 of FIG. 6 is described as being carried out by the back-end computing platform 102 of FIG. 1, which is hosting a construction management software application, but it should be understood that the example functionality 600 of FIG. 6 may be carried out by any computing platform that is capable of running the software disclosed herein. Further, it should be understood that the example functionality of FIG. 6 is merely described in this manner for the sake of clarity and explanation and that the example functionality may be implemented in various other manners, including the possibility that functions may be added, removed, rearranged into different orders, combined into fewer blocks, and/or separated into additional blocks depending upon the particular example.

As shown in FIG. 6, the example functionality 600 may begin at block 602 with the disclosed AI-based software architecture receiving, from a client device 104, a natural-language request to create a given workflow-template data object that is (i) related to a given workflow that comprises a set of steps that can be carried out using a construction management software application to carry out a construction task and (ii) comprises data related to each of the set of steps. In line with the previous discussion with respect to the example AI-based software architecture 300, the natural-language request to create a given workflow-template data object may take various forms and input thereof may be initiated at any of various times.

At block 604, the disclosed AI-based software architecture may receive image data that includes a graphical representation of the given workflow for the construction task. In line with the previous discussion with respect to the example AI-based software architecture 300, the image data may take various forms and input thereof be initiated at any of various times.

At block 606, the disclosed AI-based software architecture may, based on the natural-language request and the image data, generate a prompt for at least one generative AI model that comprises a request to generate the given workflow-template data object. In line with the discussion above with respect to the example AI-based software architecture 300, the prompt may take any of various forms.

At block 608, the disclosed AI-based software architecture may pass the prompt to the at least one generative AI model and, at block 610, the disclosed AI-based software architecture may receive, from the at least one generative AI model, a response that comprises the given workflow-template data object. In line with the previous discussion with respect to the example AI-based software architecture 300, functions of passing the generated prompt to the generative AI model and receiving the response from the generative AI model may take any of various forms (which may depend in part on where the generative AI model is hosted).

At block 612, the disclosed AI-based software architecture may present, using the client device, a visual representation of the given workflow-template data object that comprises a depiction of the data related to each of the set of steps.

While the disclosed software technology of is described in the context of a construction management software application, the disclosed software technology could also be utilized to create different types of workflow templates within any other category of software application that supports utilizing workflow templates to accomplish tasks within the software application.

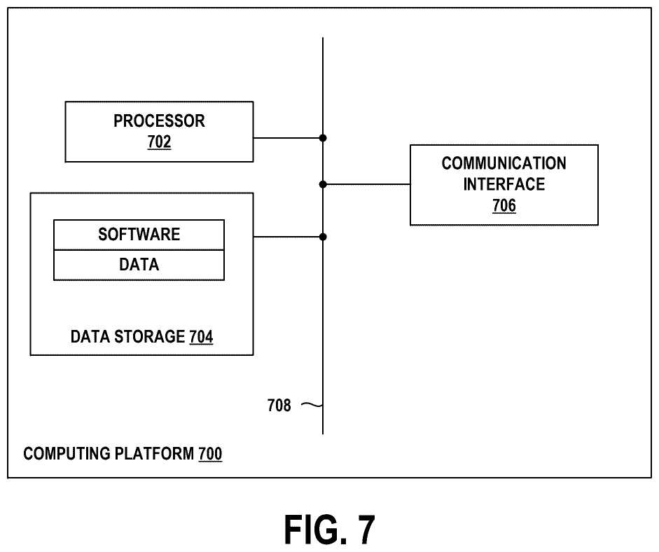

Turning now to FIG. 7, a simplified block diagram is provided to illustrate some structural components that may be included in an example computing platform 700 that may be configured to perform the platform-side functions disclosed herein. At a high level, the example computing platform 700 may generally comprise any one or more computer systems (e.g., one or more servers) that collectively include one or more processors 702, data storage 704, and one or more communication interfaces 706, each of which may be communicatively linked by a communication link 708 that may take the form of a system bus, a communication network such as a public, private, or hybrid cloud, or some other connection mechanism. Each of these components may take various forms.

For instance, the one or more processors 702 may comprise one or more processor components, such as one or more central processing units (CPUs), graphics processing units (GPUs), application-specific integrated circuits (ASICs), digital signal processor (DSPs), and/or programmable logic devices such as field programmable gate arrays (FPGAs), among other possible types of processing components. In line with the discussion above, it should also be understood that the one or more processors 702 could comprise processing components that are distributed across a plurality of physical computing devices connected via a network, such as a computing cluster of a public, private, or hybrid cloud.

In turn, the data storage 704 may comprise one or more non-transitory computer-readable storage mediums, examples of which may include volatile storage mediums such as random-access memory, registers, cache, etc. and non-volatile storage mediums such as read-only memory, a hard-disk drive, a solid-state drive, flash memory, an optical-storage device, etc. In line with the discussion above, it should also be understood that the data storage 704 may comprise computer-readable storage mediums that are distributed across a plurality of physical computing devices connected via a network, such as a storage cluster of a public, private, or hybrid cloud that operates according to technologies such as AWS for Elastic Compute Cloud, Simple Storage Service, etc.

As shown in FIG. 7, the data storage 704 may be capable of storing both (i) program instructions that are executable by the one or more processors 702 such that the example computing platform 700 is configured to perform any of the various functions disclosed herein (including but not limited to any of the platform-side functions discussed above), and (ii) data that may be received, derived, or otherwise stored by the example computing platform 700.

The one or more communication interfaces 706 may comprise one or more interfaces that facilitate communication between the example computing platform 700 and other systems or devices, where each such interface may be wired and/or wireless and may communicate according to any of various communication protocols. As examples, the one or more communication interfaces 706 may take include an Ethernet interface, a serial bus interface (e.g., Firewire, USB 3.0, etc.), a chipset and antenna adapted to facilitate any of various types of wireless communication (e.g., Wi-Fi communication, cellular communication, Bluetooth® communication, etc.), and/or any other interface that provides for wireless or wired communication. Other configurations are possible as well.

Although not shown, the example computing platform 700 may additionally have an I/O interface that includes or provides connectivity to I/O components that facilitate user interaction with the example computing platform 700, such as a keyboard, a mouse, a trackpad, a display screen, a touch-sensitive interface, a stylus, a virtual-reality headset, and/or one or more speaker components, among other possibilities.

It should be understood that the example computing platform 700 is one example of a computing platform that may be used with the examples described herein. Numerous other arrangements are possible and contemplated herein. For instance, in other examples, the example computing platform 700 may include additional components not pictured and/or more or less of the pictured components.

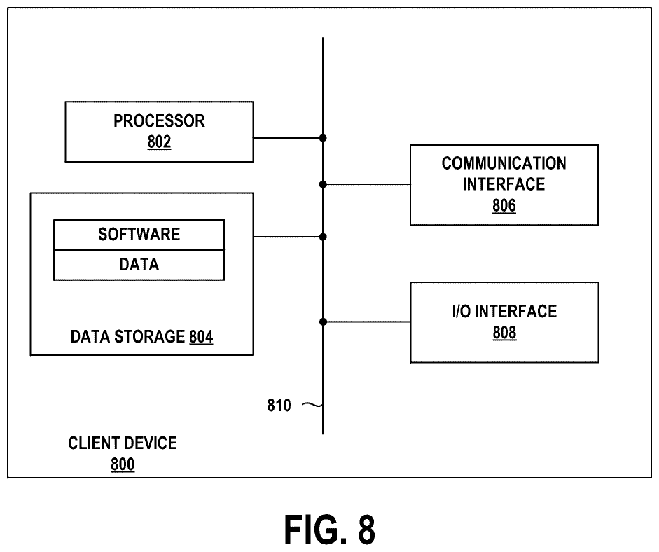

Turning next to FIG. 8, a simplified block diagram is provided to illustrate some structural components that may be included in an example client device 800 that may be configured to perform some the client-side functions disclosed herein. At a high level, the example client device 800 may include one or more processors 802, data storage 804, one or more communication interfaces 806, and an I/O interface 808, each of which may be communicatively linked by a communication link 810 that may take the form a system bus and/or some other connection mechanism. Each of these components may take various forms.

For instance, the one or more processors 802 of the example client device 800 may comprise one or more processor components, such as one or more CPUs, GPUs, ASICs, DSPs, and/or programmable logic devices such as FPGAs, among other possible types of processing components.

In turn, the data storage 804 of the example client device 800 may comprise one or more non-transitory computer-readable mediums, examples of which may include volatile storage mediums such as random-access memory, registers, cache, etc. and non-volatile storage mediums such as read-only memory, a hard-disk drive, a solid-state drive, flash memory, an optical-storage device, etc. As shown in FIG. 8, the data storage 804 may be capable of storing both (i) program instructions that are executable by the one or more processors 802 of the example client device 800 such that the example client device 800 is configured to perform any of the various functions disclosed herein (including but not limited to any of the client-side functions discussed above), and (ii) data that may be received, derived, or otherwise stored by the example client device 800.

The one or more communication interfaces 806 may comprise one or more interfaces that facilitate communication between the example client device 800 and other systems or devices, where each such interface may be wired and/or wireless and may communicate according to any of various communication protocols. As examples, the one or more communication interfaces 806 may take include an Ethernet interface, a serial bus interface (e.g., Firewire, USB 3.0, etc.), a chipset and antenna adapted to facilitate any of various types of wireless communication (e.g., Wi-Fi communication, cellular communication, Bluetooth® communication, etc.), and/or any other interface that provides for wireless or wired communication. Other configurations are possible as well.

The I/O interface 808 may generally take the form of (i) one or more input interfaces that are configured to receive and/or capture information at the example client device 800 and (ii) one or more output interfaces that are configured to output information from the example client device 800 (e.g., for presentation to a user). In this respect, the one or more input interfaces of I/O interface may include or provide connectivity to input components such as a microphone, a camera, a keyboard, a mouse, a trackpad, a touchscreen, and/or a stylus, among other possibilities, and the one or more output interfaces of the I/O interface 808 may include or provide connectivity to output components such as a display screen and/or an audio speaker, among other possibilities.

It should be understood that the example client device 800 is one example of a client device that may be used with the examples described herein. Numerous other arrangements are possible and contemplated herein. For instance, in other examples, the example client device 800 may include additional components not pictured and/or more or fewer of the pictured components.

Example embodiments of the disclosed innovations have been described above. Those skilled in the art will understand, however, that changes and modifications may be made to the embodiments described without departing from the true scope and spirit of the present invention, which will be defined by the claims.

Further, to the extent that examples described herein involve operations performed or initiated by actors, such as “humans,” “operators,” “users,” or other entities, this is for purposes of example and explanation only. The claims should not be construed as requiring action by such actors unless explicitly recited in the claim language.

What is claimed is:

1. A computing platform comprising:
at least one non-transitory computer-readable medium;
at least one processor; and
program instructions stored on the at least one non-transitory computer-readable medium that, when executed by the at least one processor, cause the computing platform to:
receive, from a client device, a natural-language request to create a given workflow-template data object that is (i) related to a given workflow that comprises a set of steps that can be carried out using a construction management software application to carry out a construction task and (ii) comprises data related to each of the set of steps;
receive image data that includes a graphical representation of the given workflow for the construction task;
based on the natural-language request and the image data, generate a prompt for at least one generative AI model that comprises a request to generate the given workflow-template data object;
pass the prompt to the at least one generative AI model;
receive, from the at least one generative AI model, a response that comprises the given workflow-template data object; and
present, using the client device, a visual representation of the given workflow-template data object that comprises a depiction of the data related to each of the set of steps.

2. The computing platform of claim 1, wherein the program instructions that, when executed by the at least one processor, cause the computing platform to generate the prompt for at least one generative AI model comprise program instructions that, when executed by the at least one processor, cause the computing platform to:
generate the prompt for at least one generative AI model that comprises (i) the natural-language request, (ii) the image data, (iii) a workflow template schema that defines a data structure for workflow-template data objects, and (iv) the request to create the given workflow-template data object.

3. The computing platform of claim 2, wherein the request to create the given workflow-template data object comprises (i) a request to extract unstructured data related to the given workflow from the image data and (ii) a request to, based on the extracted unstructured data and the workflow template schema, generate data in accordance with the workflow template schema and thereby create the given workflow-template data object.

4. The computing platform of claim 3, wherein the unstructured data comprises data related to a set of steps for the given workflow for the construction task.

5. The computing platform of claim 3, wherein the at least one generative AI model comprises a first generative AI model and a second generative AI model,
wherein the prompt comprises a first prompt and a second prompt,
wherein the program instructions that, when executed by the at least one processor, cause the computing platform to generate the prompt for at least one generative AI model comprise program instructions that, when executed by the at least one processor, cause the computing platform to:
generate the first prompt that comprises (i) the image data and (ii) the request to extract the unstructured data related to the given workflow from the image data; and
generate the second prompt that comprises (i) the extracted unstructured data and (ii) the request to, based on the extracted unstructured data and the workflow template schema, generate data in accordance with the workflow template schema and thereby create the given workflow-template data object,
wherein the program instructions that, when executed by the at least one processor, cause the computing platform to pass the prompt to the at least one generative AI model comprise program instructions that, when executed by the at least one processor, cause the computing platform to:
pass the first prompt to the first generative AI model; and
pass the second prompt to the second generative AI model.

6. The computing platform of claim 3, wherein the at least one generative AI model comprises a multi-modal generative AI model.

7. The computing platform of claim 1, further comprising program instructions stored on the non-transitory computer-readable medium that, when executed by the at least one processor, cause the computing platform to:
initialize an initial workflow-template data object, and
wherein the program instructions that, when executed by the at least one processor, cause the computing platform to generate the prompt for at least one generative AI model comprise program instructions that, when executed by the at least one processor, cause the computing platform to:
based on (i) the natural-language request, (ii) the image data, and (iii) the initial workflow-template data object, generate a prompt for at least one generative AI model that comprises a request to generate the given workflow-template data object.

8. The computing platform of claim 7, further comprising program instructions stored on the non-transitory computer-readable medium that, when executed by the at least one processor, cause the computing platform to:
extract, from the natural-language request, a request to initialize the initial workflow-template data object, and
wherein the program instructions that, when executed by the at least one processor, cause the computing platform to initialize the initial workflow-template data object comprise program instructions that, when executed by the at least one processor, cause the computing platform to:
based on the request to initialize the initial workflow-template data object, initialize the initial workflow-template data object.

9. The computing platform of claim 1, wherein the prompt is a first prompt, and
the computing platform further comprises program instructions stored on the non-transitory computer-readable medium that, when executed by the at least one processor, cause the computing platform to:
after receiving the given workflow-template data object, receive a natural-language request to update the given workflow-template data object;
generate a second prompt for the at least one generative AI model that comprises (i) the natural-language request to update the given workflow-template data object (ii) the given workflow-template data object, and (iii) a request to, based on the natural-language request and the given workflow-template data object, generate an updated workflow-template data object
pass the second prompt to the at least one generative AI model; and
receive, from the at least one generative AI model, a response that comprises the updated workflow-template data object.

10. The computing platform of claim 9, further comprising program instructions stored on the non-transitory computer-readable medium that, when executed by the at least one processor, cause the computing platform to:
after presenting the visual representation of the given workflow-template data object, present, using the client device, a visual representation of the updated workflow-template data object.

11. A non-transitory computer-readable medium having stored thereon program instructions that, when executed by at least one processor, cause a computing platform to:
receive, from a client device, a natural-language request to create a given workflow-template data object that is (i) related to a given workflow that comprises a set of steps that can be carried out using a construction management software application to carry out a construction task and (ii) comprises data related to each of the set of steps;
receive image data that includes a graphical representation of the given workflow for the construction task;
based on the natural-language request and the image data, generate a prompt for at least one generative AI model that comprises a request to generate the given workflow-template data object;
pass the prompt to the at least one generative AI model;
receive, from the at least one generative AI model, a response that comprises the given workflow-template data object; and
present, using the client device, a visual representation of the given workflow-template data object that comprises a depiction of the data related to each of the set of steps.

12. The non-transitory computer-readable medium of claim 11, wherein the program instructions that, when executed by the at least one processor, cause the computing platform to generate the prompt for at least one generative AI model comprises program instructions that, when executed by the at least one processor, cause the computing platform to:
generate a prompt for at least one generative AI model that comprises (i) the natural-language request, (ii) the image data, (iii) a workflow template schema that defines a data structure for workflow-template data objects, and (iv) the request to create the given workflow-template data object.

13. The non-transitory computer-readable medium of claim 12, wherein the request to create the given workflow-template data object comprises (i) a request to extract unstructured data related to the given workflow from the image data and (ii) a request to, based on the extracted unstructured data and the workflow template schema, generate data in accordance with the workflow template schema and thereby create the given workflow-template data object.

14. The non-transitory computer-readable medium of claim 13, wherein the at least one generative AI model comprises a first generative AI model and a second generative AI model,
wherein the prompt comprises a first prompt and a second prompt,
wherein the program instructions that, when executed by the at least one processor, cause the computing platform to generate the prompt for at least one generative AI model comprise program instructions that, when executed by the at least one processor, cause the computing platform to:
generate the first prompt that comprises (i) the image data and (ii) the request to extract the unstructured data related to the given workflow from the image data; and
generate the second prompt that comprises (i) the extracted unstructured data and (ii) the request to, based on the extracted unstructured data and the workflow template schema, generate data in accordance with the workflow template schema and thereby create the given workflow-template data object,
wherein the program instructions that, when executed by the at least one processor, cause the computing platform to pass the prompt to the at least one generative AI model comprise program instructions that, when executed by the at least one processor, cause the computing platform to:
pass the first prompt to the first generative AI model; and
pass the second prompt to the second generative AI model.

15. The non-transitory computer-readable medium of claim 11, further having stored thereon program instructions that, when executed by the at least one processor, cause the computing platform to:
initialize an initial workflow-template data object, and
wherein the program instructions that, when executed by the at least one processor, cause the computing platform to generate the prompt for at least one generative AI model comprise program instructions that, when executed by the at least one processor, cause the computing platform to:
based on (i) the natural-language request, (ii) the image data, and (iii) the initial workflow-template data object, generate a prompt for at least one generative AI model that comprises a request to generate the given workflow-template data object.

16. The non-transitory computer-readable medium of claim 15, further having stored thereon program instructions that, when executed by the at least one processor, cause the computing platform to:
extract, from the natural-language request, a request to initialize the initial workflow-template data object, and
wherein the program instructions that, when executed by the at least one processor, cause the computing platform to initialize the initial workflow-template data object comprise program instructions that, when executed by the at least one processor, cause the computing platform to:
based on the request to initialize the initial workflow-template data object, initialize the initial workflow-template data object.

17. The non-transitory computer-readable medium of claim 11, wherein the prompt is a first prompt, and
the non-transitory computer readable medium further having stored thereon program instructions that, when executed by the at least one processor, cause the computing platform to:
after receiving the given workflow-template data object, receive a natural-language request to update the given workflow-template data object;
generate a second prompt for the at least one generative AI model that comprises (i) the natural-language request to update the given workflow-template data object (ii) the given workflow-template data object, and (iii) a request to, based on the natural-language request and the given workflow-template data object, generate an updated workflow-template data object
pass the second prompt to the at least one generative AI model; and
receive, from the at least one generative AI model, a response that comprises the updated workflow-template data object.

18. A method carried out by a computing platform, the method comprising:
receiving, from a client device, a natural-language request to create a given workflow-template data object that is (i) related to a given workflow that comprises a set of steps that can be carried out using a construction management software application to carry out a construction task and (ii) comprises data related to each of the set of steps;
receiving image data that includes a graphical representation of the given workflow for the construction task;
based on the natural-language request and the image data, generating a prompt for at least one generative AI model that comprises a request to generate the given workflow-template data object;
passing the prompt to the at least one generative AI model;
receiving, from the at least one generative AI model, a response that comprises the given workflow-template data object; and
presenting, using the client device, a visual representation of the given workflow-template data object that comprises a depiction of the data related to each of the set of steps.

19. The method of claim 18, wherein generating the prompt for at least one generative AI model comprises:
generating a prompt for at least one generative AI model that comprises (i) the natural-language request, (ii) the image data, (iii) a workflow template schema that defines a data structure for workflow-template data objects, and (iv) the request to create the given workflow-template data object, and
wherein the request to create the given workflow-template data object comprises (i) a request to extract unstructured data related to the given workflow from the image data and (ii) a request to, based on the extracted unstructured data and the workflow template schema, generate data in accordance with the workflow template schema and thereby create the given workflow-template data object.

20. The method of claim 18, further comprising:
initializing an initial workflow-template data object, and
wherein generating the prompt for at least one generative AI model comprises:
based on (i) the natural-language request, (ii) the image data, and (iii) the initial workflow-template data object, generating a prompt for at least one generative AI model that comprises a request to generate the given workflow-template data object.
